(19) United States
(12) Patent Application Publication
(10) Pub. No.: US 2008/0288301 A1
(43) Pub. Date: Nov. 20, 2008

(54) Data processing system and method

(75) Inventors: James M. Emling, Dousman, WI (US); John Wustrack, Whitefish Bay, WI (US)

Correspondence Address: FOLEY & LARDNER LLP, 777 EAST WISCONSIN AVENUE, MILWAUKEE, WI, 53202-5306, US

(73) Assignee: Zywave, Inc.

(21) Appl. No.: 12/154,019

(22) Filed: May 20, 2008

Related U.S. Application Data
(63) Continuation-in-part of application No. 11/701,970, filed on Feb. 2, 2007.
(60) Provisional application No. 60/939,320, filed on May 21, 2007.
(60) Provisional application No. 60/764,899, filed on Feb. 3, 2006.
(60) Provisional application No. 60/775,482, filed on Feb. 21, 2006.
(60) Provisional application No. 60/802,353, filed on May 22, 2006.
(60) Provisional application No. 60/802,671, filed on May 23, 2006.
(60) Provisional application No. 60/812,689, filed on Jun. 9, 2006.

(51) Int. Cl. G06Q 40/00

(52) U.S. Cl. 705/4

(57) ABSTRACT

Systems and methods are presented for managing at least one database in the insurance brokerage industry. A database is configured to store information regarding a plurality of insurance brokerage industry projects. The database is configured to allow access to brokers via the broker user interface logic. The brokers are permitted to add information in the database concerning the plurality of insurance brokerage industry projects. The database is configured to allow access to the service provider via the application service provider user interface logic. The service provider has a relationship with the brokers in which the service provider provides data management applications for the plurality of insurance brokerage industry projects.

### CROSS-REFERENCE TO RELATED PATENT APPLICATIONS

The present application claims priority to U.S. Prov. Patent Application Ser. No. 60/939,320 entitled “Data Processing System and Method,” filed May 21, 2007 and is a Continuation-in-Part of U.S. application Ser. No. 11/701,970, entitled “Data Processing System and Method,” filed Feb. 2, 2007, pending, which claims priority to U.S. Prov. Patent Application Ser. No. 60/802,353 entitled “Data Processing System and Method,” filed May 22, 2006; U.S. Prov. Patent Application Ser. No. 60/802,671, entitled “Data Processing System and Method,” filed May 23, 2006; U.S. Prov. Patent Application Ser. No. 60/812,689, entitled “Data Processing System and Method,” filed Jun. 9, 2006; U.S. Prov. Patent Application Ser. No. 60/775,482, entitled “Data Processing System and Method,” filed Feb. 21, 2006; and U.S. Prov. Patent Application Ser. No. 60/764,899, entitled “Data Processing System and Method,” filed Feb. 3, 2006, all of which are hereby incorporated by reference herein.

### BACKGROUND

The present disclosure relates generally to the field of data and file management. More particularly, the present disclosure relates to the field of data management using a communication network, such as the Internet, for the insurance brokerage industry (e.g., employee benefits/health insurance brokerage industry, property and casualty insurance brokerage industry, etc.).

In the insurance brokerage industry, it is often desirable to share data through a communication network. For example, various application service providers (“ASPs”) exist in the insurance brokerage industry which provide computer-based services to customers (i.e., users) of the ASP over the Internet. The computer-based services may include providing access to one or more software applications which execute on servers operated by the ASP and which are provided to the customers via the Internet. In order to effectively utilize the services provided by ASPs, it is often necessary for the users of the ASP to upload and download files to and from the ASP's central data center. As a further example, it is often desirable for companies to collaborate in real-time with its customers (or suppliers or other parties), such as on the creation of certain documents, presentations, or other files. Often, the process of sharing data through a network can become very tedious, particularly when the user desires to upload or download multiple files. Additionally, it is often tedious to access the files from other applications that may reside on the user's computer, e.g., for purposes of reading or modifying the file, for purposes of attaching the file to an e-mail, and so on. A challenge that has been encountered in providing a more seamless solution is that it is often desirable for customers to be able to use such files in combination with other network resources, such as applications or files available via a company intranet. Also, it is often desirable for multiple users (e.g., multiple employees at a company) to have common access to such files. It would be desirable to provide a more seamless integration of data files provided by an ASP's server with other resources available to users of the ASP.

Although certain features and advantages are described, it will be appreciated that the teachings herein may also be used to implement systems and methods that have other features and advantages different than those described.

### SUMMARY

One embodiment relates to a computer-implemented data processing system including a database, a file server coupled to the database, a broker user interface logic coupled to the file server, and an application service provider user interface logic coupled to the file server. The database being configured to store information regarding a plurality of insurance brokerage industry projects. The broker user interface logic being configured to provide a broker user interface accessible to brokers from a client device. The broker user interface logic also being configured to receive commands via a communications network from the client device to access a data file in the database and to permit the data file to be displayed as a local file in a file directory on the client device and to permit the brokers to add information in the database concerning the plurality of insurance brokerage industry projects. The application service provider user interface logic being configured to provide an application service provider user interface accessible to a service provider, the service provider having relationships with the brokers in which the service provider provides data management applications for the plurality of insurance brokerage industry projects.

One embodiment relates to a computer-implemented data processing system including a database, a file server coupled to the database, a content template logic, a broker user interface logic coupled to the file server, and an application service provider user interface logic coupled to the file server. The database being configured to store information regarding a plurality of insurance brokerage industry projects. The broker user interface logic being configured to provide a broker user interface accessible to brokers from a client device. The broker user interface logic also being configured to receive commands via a communications network from the client device to access a data file in the database and to permit the data file to be displayed as a local file in a file directory on the client device and to permit the brokers to add information in the database concerning the plurality of insurance brokerage industry projects. The application service provider user interface logic being configured to provide an application service provider user interface accessible to a service provider. The service provider having relationships with the brokers in which the service provider provides data management applications for the plurality of insurance brokerage industry projects. The file server cooperates with the client device to display a portion of a data file on the client device as a local system file. The portion of a data file is configured to be modified by a client device and the file server synchronizes a data file modification between the client device and the database. The application service provider interface logic receives at least a file command from a plurality of client devices and cooperates with the plurality of client devices to transmit a data file based on a control signal sent by a data access layer logic.

One embodiment relates to a computer-implemented method for database management including storing at least a data file in an application service provider database. The application service provider database being configured to store information regarding a plurality of insurance brokerage industry projects. The method further includes receiving at least a file command from a plurality of client devices to an application service provider server and communicating the data file to one of the plurality of client devices. The method also includes displaying the data file as a local system file in a file directory on the client device. The application service provider database further includes an application service provider user interface logic coupled to the application service provider server. The application service provider user interface logic being configured to provide an application service provider user interface accessible to a service provider. The service provider having relationships with the brokers in which the service provider provides data management applications for the plurality of insurance brokerage industry projects. The client device is configured to include a broker user interface logic coupled to the application service provider server. The broker user interface logic being configured to provide a broker user interface accessible to brokers from the client device. The broker user interface logic also being configured to receive commands via a communications network from the client device to access a data file in the application service provider database and to permit the data file to be displayed as a local file in a file directory on the client device and to permit the brokers to add information in the database concerning the plurality of insurance brokerage industry projects.

### BRIEF DESCRIPTION OF THE DRAWINGS

FIG. 1 is an illustration of a system for facilitating data and file management, according to one embodiment.

FIG. 2 is a screen shot of a browser-based user interface next to a screen shot of a desktop-based user interface showing remote files and folders, according to one embodiment.

FIG. 3 is an illustration of a system for facilitating data management, according to a more detailed example embodiment.

FIGS. 4A-4D are screen shots of a user interface for modifying a data file over a communication network using a data management system, according to one embodiment.

FIGS. 5 and 6 are screen shots of a user interface for saving a document in a data management system, according to one embodiment.

FIG. 7 is a screen shot of a user interface for attaching a document stored within a web-based application to an email utilizing a data management system, according to one embodiment.

FIG. 8 is a system architecture diagram showing aspects of the system of FIG. 3 in greater detail, according to one embodiment.

FIGS. 9A-9C are screen shots of a desktop taskbar icon, according to one embodiment.

FIG. 10 is a screen shot of a registry persistence, according to one embodiment.

FIG. 11 is an expanded illustration of a system for facilitating data management, according to one embodiment.

FIGS. 12A-12B are screen shots illustrating the steps undertaken to log into a data management system for the insurance brokerage industry, according to one embodiment.

FIGS. 13A-B are illustrations of an Application Service Provider's content generation template engine, according to one embodiment.

FIG. 14 is a screen shot of a log-in screen for a content generation template engine, according to one embodiment.

FIG. 15 is a screen shot of a insurance brokerage industry template, according to one embodiment.

FIG. 16 is a screen shot of search function for a insurance brokerage industry template, according to one embodiment.

FIG. 17 is a screen shot of search function for a insurance brokerage industry template, according to one embodiment.

FIG. 18 is a screen shot of a favorites option for a insurance brokerage industry template, according to one embodiment.

FIG. 19 is a screen shot of a selection basket for a insurance brokerage industry template, according to one embodiment.

FIGS. 20A-20B are illustrations of the merger field functionality for a insurance brokerage industry template, according to one embodiment.

FIG. 21 is a screen shot of a distribution calendar option for a insurance brokerage industry template, according to one embodiment.

FIG. 22 is a screen shot of a template grouping option for a insurance brokerage industry template, according to one embodiment.

FIG. 23 is screen shot of an express campaign option for a insurance brokerage industry template, according to one embodiment.

FIGS. 24A-24C are screen shots of a report designer window provided by the Application Service Provider, according to one embodiment.

FIG. 25 is an screen shot of a data explorer window for designing a customized template, according to one embodiment.

FIG. 26 is a screen shot of a properties window for designing a customized template, according to one embodiment.

FIG. 27 is a screen shot of a filter designer window provided by the Application Service Provider, according to one embodiment.

FIG. 28 is a screen shot of a filter properties window, according to one embodiment.

FIGS. 29A-29B are illustrations of the expression feature, according to one embodiment.

FIGS. 30A-30B are screen shots of an operator section and a functions section of an expressions editor window, according to one embodiment.

FIG. 31 is a screen shot of a schedule explorer window, according to one embodiment.

FIG. 32 is a screen shot of a publication explorer window, according to one embodiment.

FIGS. 33 and 34 are screen shots of the data management system's user account page and sales view page, according to one embodiment.

FIG. 35 is a screen shot of the data management system basic search feature page, according to one embodiment.

FIGS. 36A-36D are screen shots illustrating the steps undertaken to utilize the RFP wizard, according to one embodiment.

FIGS. 37A-37D are screen shots illustrating the steps undertaken to create a proposal, according to one embodiment.

### DETAILED DESCRIPTION OF THE EXEMPLARY EMBODIMENTS

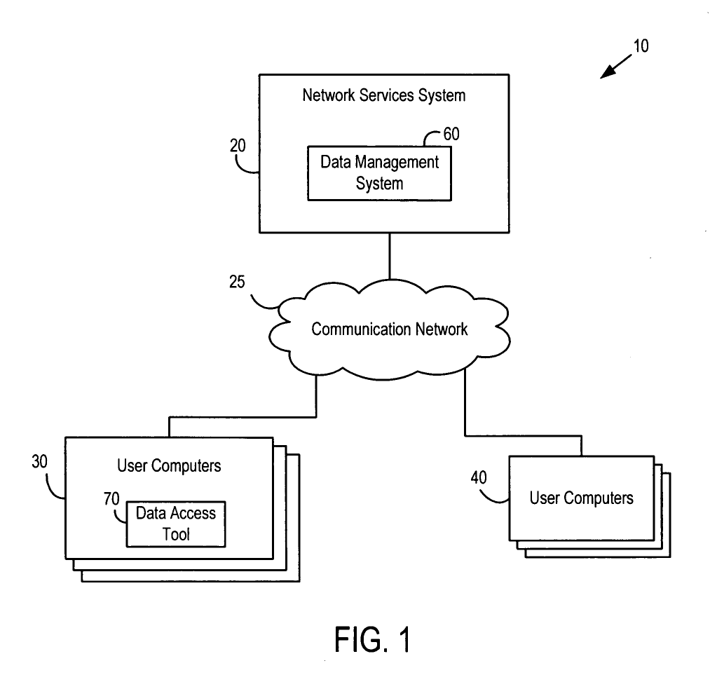

Referring now to FIG. 1, an embodiment of a system 10 is shown. System 10 comprises a network services system 20, user computers 30, and user computers 40. Network services system 20 may, for example, comprise a computer system (e.g., one or more networked servers) operated by an application service provider or other entity. Network services system 20 may provide computer-based services to users through communication network 25, such as the Internet. User computers 30 and 40 may each comprise individual or multiple computers connected to communication network 25, individual or multiple computers connected to communication network 25 through another network (e.g., an enterprise intranet), or other arrangements.

Network services system 20 permits user computers 30 and 40 to access data in data management system 60 through computer network 25. The data may, for example, be accessed using a browser such as Internet Explorer®. (Internet Explorer® is a registered trademark of Microsoft Corporation.) In one embodiment, user computers 30 and 40 include user computers 30 that have a data access tool 70. Data access tool 70 creates and maps a directory or file tree of files and folders corresponding to the remote files and folders stored at data management system 60 so that they are treated within the user's native operating environment (e.g., a Windows® operating system, an open source operating system, etc.) as though they are local files or folders. (Windows® is a registered trademark of Microsoft Corporation.) A local file is defined as any file stored within the client's computer, database or intranet (i.e. drives A: to Z:). For purposes of providing an example, it is assumed herein that the system 10 is used in connection with user computers 30 and 40 having a Windows operating system, although it will be appreciated that other operating systems could also be used.

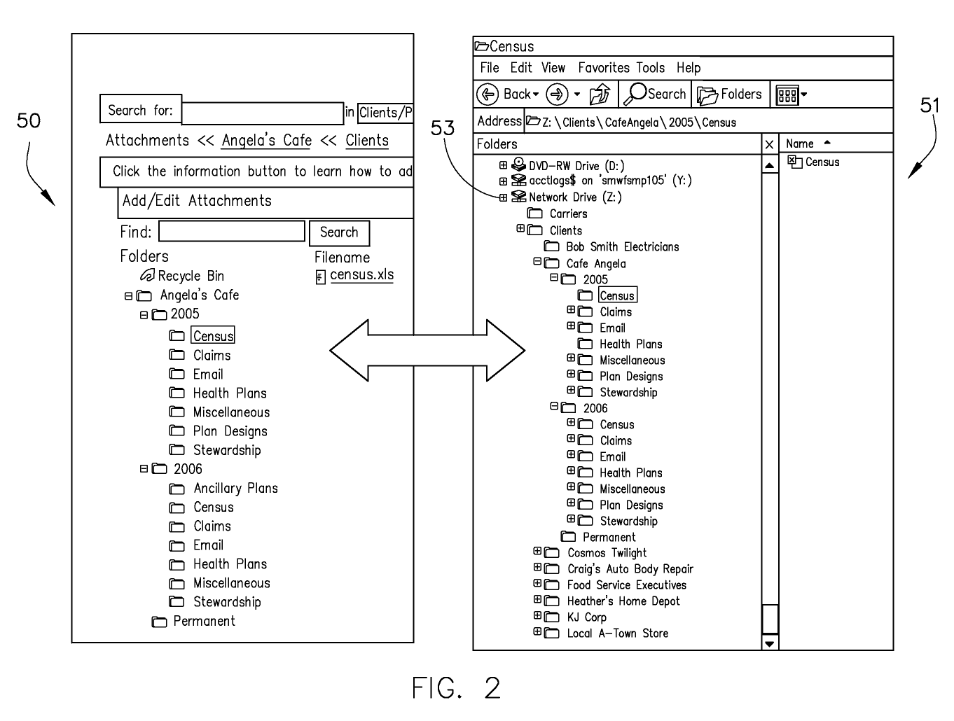

Referring now to FIG. 2, FIG. 2 is a screen shot of a browser-based user interface 50 next to a screen shot of a desktop-based user interface 51. User interface 50 is provided by browser software and comprises a directory tree structure including various file folders and files within the file folders. User interface 50 is configured to be readily understood by a user that is configured with a desktop file management application such as Windows Explorer, although the manner in which files are accessed is somewhat more tedious due to the manner in which browsers operate. To access a file, the user selects the file and then is prompted to specify a location for saving the file (e.g., on the user's local hard drive). After specifying a location for saving the file, a copy of the file is downloaded to the user's computer. Any edits that are made to the file are saved locally and not on the version of the file stored by data management system 60. If it is desired to save any edits to the version of the file stored by data management system 60, then the file is re-uploaded to data management system 60 using a process that mirrors in reverse the process for downloading the file.

User interface 51 is provided using access tool 70 and comprises a directory tree structure including various file folders and files within the file folders. In one embodiment, as described in greater detail below, access tool 70 creates and maps a directory or file tree of files and folders (corresponding to the remote files and folders) which appears within the user's Windows interface under a separate letter drive 53 (e.g., in FIG. 2, the Z: drive) just as the files and folders would appear if they were local files saved in the user's local hard drive. In other exemplary embodiments, the Windows interface may be based on operating platforms, such as, Linux®, Unix®, Apple®, Palm OS®, Mozilla® or Netscape®. Linux is a registered trademark of Linux Mark Institute. Unix is a registered trademark of X/Open Company Ltd. Apple is a registered trademark of Apple Incorporated. Palm OS is a registered trademark of Palm Trademark Holding Company, LLC. Mozilla is a registered trademark on Mozilla Foundation. Netscape is a registered trademark of Netscape.

In addition to appearing within the user's Windows interface, access tool 70 applies all default Windows functionality to the remote files and folders to enable the remote files and folders to be treated the same as a local file or folder would be treated in Windows and Windows-based applications or products. Access tool 70 is configured to perform functions such as, cut, copy, paste, delete, add, open/view, edit properties, move, rename and send on the remote files just as if they were local files. In addition, access tool 70 is configured to allow the movement or copying of multiple files and/or folders at once (drag-and-drop). Windows-based applications and products recognize and work with the remote files and folders, in the same way they would with local files and folders because access tool 70 applies properties to the remote files and folders that mimic local files and folders. Accordingly, the system may be configured to scan documents directly into the remote folders; save documents to a remote folder directly from the user's local Windows-based applications; attach remote files to e-mails; save attachments from emails directly into a remote folder; view the total space used by a remote file or folder; and so on.

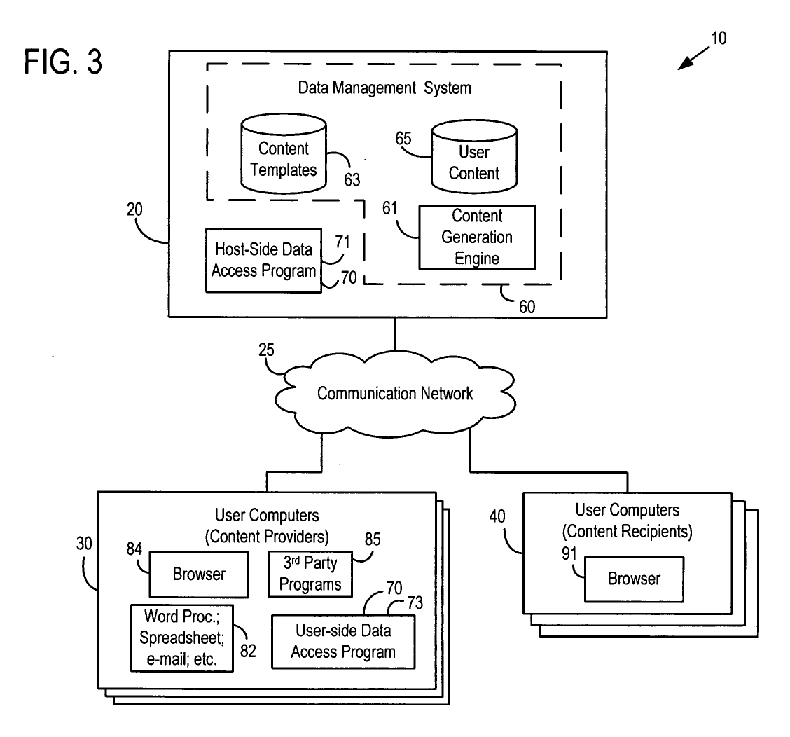

Referring now to FIG. 3, FIG. 3 is similar to FIG. 1 except that it provides a more detailed example. In the example of FIG. 3, network services system 20 is shown as providing a data management system 60. Data management system 60 may be used to manage content such as documents (e.g., word processing documents, spreadsheet documents, graphics documents, etc.), media (e.g., music, video, etc.), or other content (e.g., technical data, medical/patient data, purchasing data, customer data, etc.). For purposes of providing an example, it will be assumed herein that data management system 60 is used in connection with managing documents.

The users of user computers 30 and 40 may be entities (e.g., corporate entities, governmental entities, non-profit entities, and so on) and/or users that are private individuals (e.g., individuals acting on their own behalf). In the example of FIG. 3, user computers 30 are shown as being associated with content providers and user computers 40 are shown as being associated with content recipients. The content providers may, for example, be businesses (using user computers 30) that provide services to entities outside their institutional boundaries, e.g., to customers or clients (using user computers 40). In such an embodiment, network services system 20 may be used to facilitate the delivery of content generated by one or more content providers to their customers or clients. Businesses that provide services to customers or clients and use data management system 60 more extensively may utilize data access tool 70. Customers or clients may also utilize data access tool 70. Alternatively, if the customers or clients have less frequent interactions with data management system 60, the customers or clients may prefer to access data management system 60 with a web browser, since it does not involve installation of additional software. As will be appreciated, in at least some instances, the content may be provided to the client or customer in another manner, e.g., in hardcopy format.

The content may be generated by the users of user computers 30, 40, by data management system 60, and/or by another system. In the example of FIG. 3, the content is generated at least partially by data management system 60. Thus, data management system 60 comprises content generation engine 61, content templates database 63, and user content database 65. (Herein, the term “database” refers to any data storage system.) Content generation engine 61 may be configured to access templates stored in contents templates database 63 and user-provided content stored in user database 65 and, using the templates and user-provided content, generate content that is suitable for presentation to the customers or clients. For example, if the content is documents, content generation engine 61 may be configured to access document templates stored in content templates database 63 and generate documents based on the templates. The templates may provide generic information, and generation engine 61 may be used to generate custom documents based on the templates and based on context-specific information stored in user content database 65.

For example, if a report is to be generated by content generation engine 61, then a content provider may store a spreadsheet file in user content database 65 that may contain raw data to be used by content generation engine 61 to populate a report template to generate the report. The content provider may also store a word processing document containing other customized text for the report. Content generation engine 61 may then process the information contained in the spreadsheet file and/or the word processing file to generate the customized report. Other data may also be incorporated, for example, to incorporate logos or other branding information of the content provider. Content generation engine 61 may also access other sources of information and use that information to process information provided by the content provider. For example, if the spreadsheet specifies that a certain quantity of services has been provided, then content generation engine 61 may access a pricing engine that generates a price for each unit of services, so that the report includes a total fee for the services provided. Once the content (in this example, the report) is generated, it may be stored in user content database 65.

The access tool 70 may be configured to access the content and modify the content per content provider commands. For example, the content provider may access the report to make final changes to the report before it is presented to the content recipient (e.g., to manually insert additional information into the report, to delete irrelevant text, etc.). Alternatively, the content provider may wish to modify a spreadsheet or the word processing document and then regenerate the report. In FIG. 3, user computers 30 are shown as comprising other generic programs 82 which may be used to access and modify the content in data management system 60 (e.g., word processing programs, spreadsheet programs, e-mail programs, presentation programs, media players, and so on). From the perspective of the user, such access may occur directly as though the report were located on the user's hard drive, without the need to download and save a local copy of the report from data management system 60. The report may also be accessed by another access program 84 (e.g., a web browser, such as Internet Explorer using user interface 50) or by third party programs 85.

Access tool 70 is configured to permit users to access content stored by data management system 60 outside of the user's web browser (e.g., Internet Explorer, Netscape, etc.). In FIG. 3, the access tool 70 is shown as comprising a host-side data access program (“host program”) 71 and a client-side data access program (“client program”) 73. According to one embodiment, host program 71 is implemented using a WebDAV server. (Herein, “WebDAV” refers to Web-based Distributed Authoring and Versioning or the set of extensions to the HTTP protocol defined by the WebDAV Internet Engineering Task Force (IETF) working group which allows users to collaboratively edit and manage files on remote web servers.)

According to one embodiment, client program 73 is a Windows® shell program that runs on a user's local system. According to one embodiment, client program 73 creates and maps a directory or file tree of remote files and folders (corresponding to the remote content) which appears within the user's Windows interface under a separate letter drive (e.g., such as the Z: drive) just as the files and folders would appear if they were local files saved in the user's local hard drive. In addition to appearing within the user's Windows interface, client program 73 applies all default Windows functionality to the remote files and folders to enable the remote files and folders to be treated the same as a local file or folder would be treated in Windows and Windows-based applications or products. For example, according to one embodiment, the basic folder and file level operations of Windows are applied to the remote files and folders. Thus, data management system 60 provides users with easy and familiar access to all the folders, files, and attachments associated with the application provided over the Web by network services system 20.

Client program 73 is configured to perform functions such as, cut, copy, paste, delete, add, open/view, edit properties, move, rename and send on the remote files and folders just as if they were local files. In addition, client program 73 allows a user to move or copy multiple files and/or folders at once (drag-and-drop). Windows-based applications and products recognize and work with the remote files and folders, in the same way they would with local files and folders because client program 73 applies properties to the remote files and folders that mimic local or resident files and folders. Accordingly, a user is able to scan documents directly into the remote folders; save documents to a remote folder directly from the user's local Windows-based applications, such as word processing applications (e.g., Word®), spreadsheet applications (e.g., Excel®), presentation applications (e.g., PowerPoint®), etc.; attach remote files and folders to e-mails in e-mail applications (e.g., Outlook®); save attachments from emails directly into a remote folder; view the total space used by a file or folder; and so on.

In one embodiment, when the user accesses a remote file and edits it, the user accesses the file directly from data management system 60. As the user makes changes to the file and saves those changes, the changes are saved directly at data management system 60. No local cache copy of the document is made on the user's hard drive. Of course, if the user wishes to save a copy of the remote file on the user's local system, the user may do that by copying the file to the user's local system (e.g., the user's hard drive).

According to one embodiment, access tool 70 synchronizes the directory listing or hierarchy of remote folders and files that appears within the user's system in real-time (or near real-time) with information concerning the directory listing of files and folders stored by data management system 60. Thus, if a user wants to create a new file or folder in the virtual drive mapped by client program 73, the access tool 70 is configured to create the new file or folder which will substantially instantaneously appear within the listing of files and folders provided by data management system 60. The architecture (e.g., file structure) of the virtual drive may be cached locally to facilitate this synchronization process and to increase synchronization speed. An example of such a synchronization process includes storing a data file on an ASP server which can be retrieved by a local computing device, modifying the data file by utilizing the local computing device and saving the modified file to the ASP server. Another example includes a retrieving function that utilizes a customized customer file map and/or a computing device that processes a plurality of customer request to access/modify/save data files on the ASP.

The file structure of the virtual drive may be real or may be a logical construct. The files need not be physically stored in a manner which bears any particular relation to the file structures displayed to users. For example, all of the user files stored by data management system 60 may be stored in a single-level directory, and mapping logic may be used to map the files into multiple levels of logical folders and subfolders. According to one embodiment, data management system 60 is configured to sort through each of these files and folders and create a virtual directory within a user's computer system (e.g., on the user's desktop) that includes (as remote files and folders) the folders and files to which a particular user has access rights.

According to one embodiment, access tool 70 is configured to create a directory of remote files and folders within a user's system consisting only of those files for which the user has access rights and not those for which it does not have access rights. Accordingly, the user logging-in to the system of network services system 20 through access tool 70 is able to view only those files and folders the user is authorized to view. In some instances, multiple individuals from different entities may be able to view, edit, delete, etc. (depending on access rights) the same folder, file, or document or otherwise collaborate on the development of a file or document. Thus, if each content provider has a set of clients that access user content database 65, each content provider may be given the ability to access its own data and that of its clients, but not the content of other content providers or their clients (i.e., assuming clients between the content providers do not overlap). Each content recipient may be given the ability to access its own content but not the content of any other content recipient or of any content provider.

As will be appreciated, different individuals within a given entity may also be given different levels of access rights. The folders and files included within the virtual directory created by data management system 60 are displayed according to an appropriate set of business rules and access rights. The display provided to a particular user (including the files and folders displayed to the user) is determined based on the access rights of the user. Moreover, basic folder and file level operations (e.g., delete, add, open/view, edit (properties), move and rename) available to a particular user may be customized based on the rules of the application provided by the application service provide and user security rules.

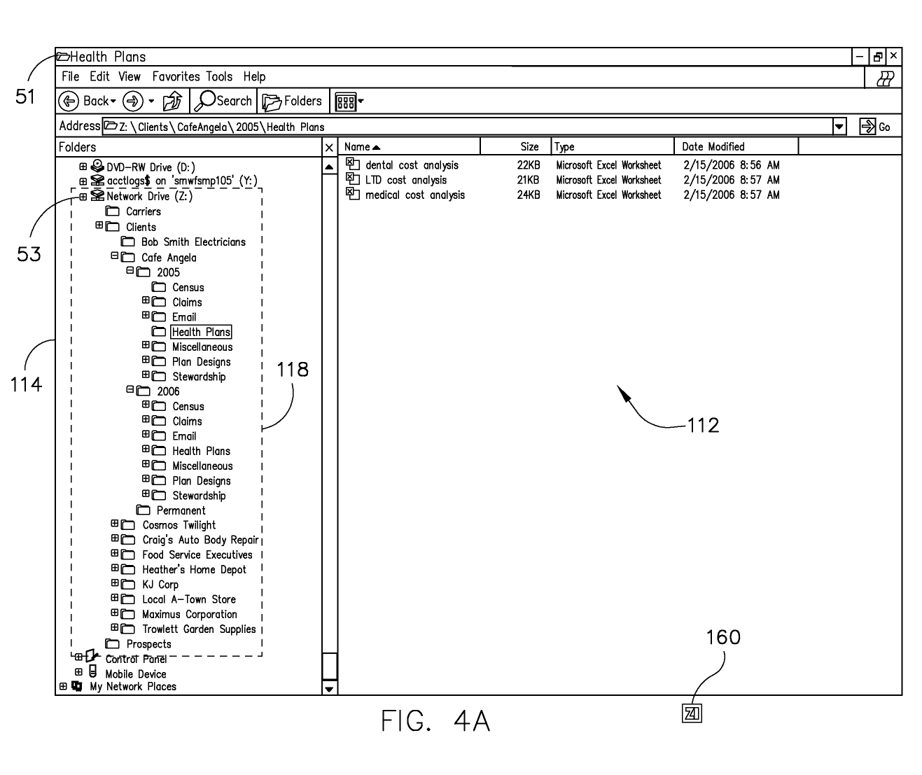

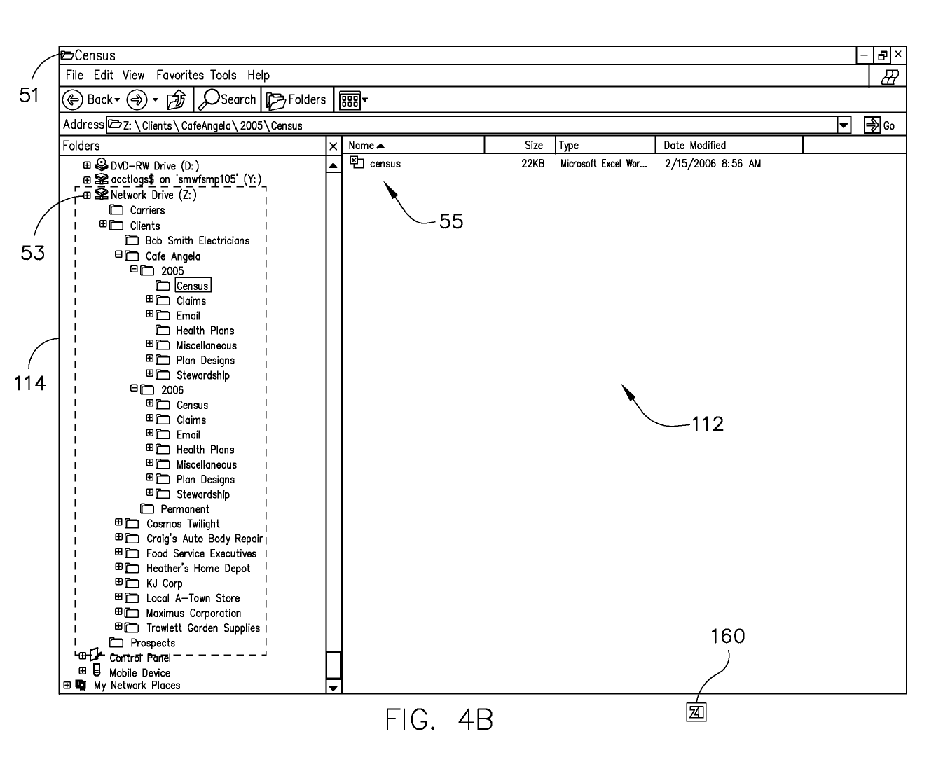

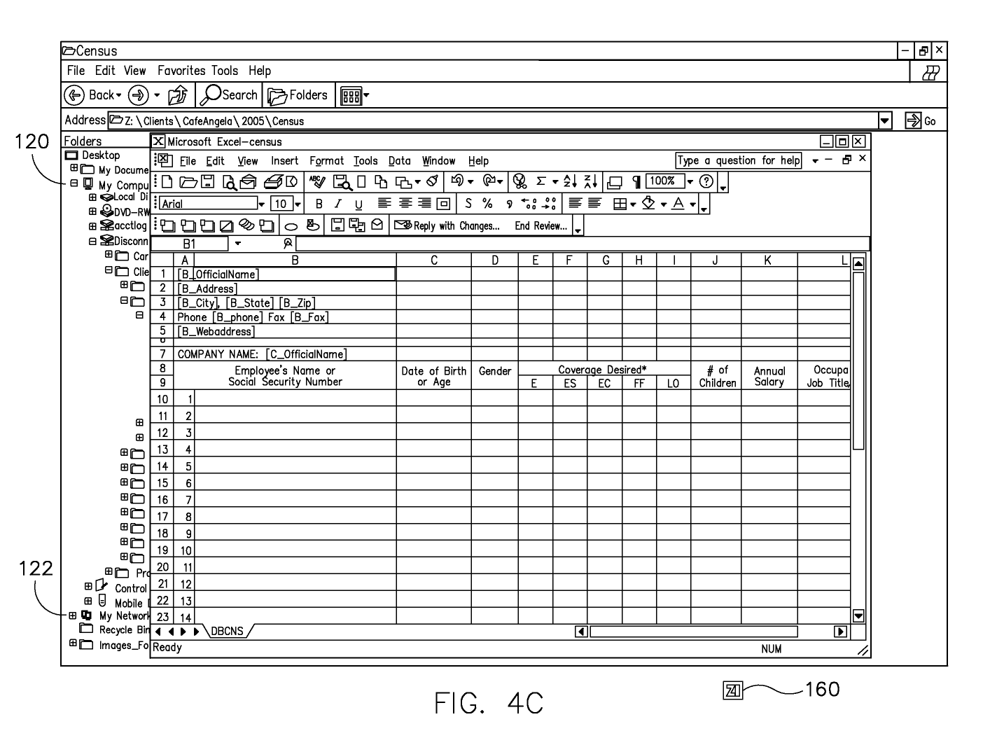

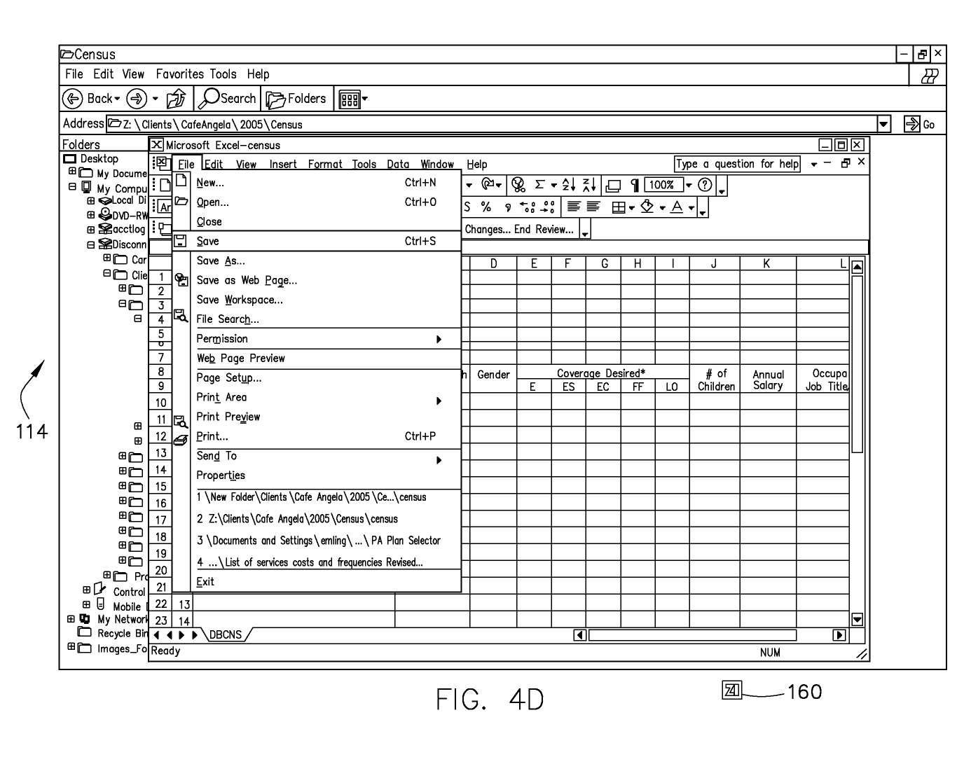

Referring now to FIGS. 4A-4D, user interface 51 provided by client program 73 for data management system 60 is illustrated in greater detail. As illustrated in FIGS. 4A-4D, when client program 73 is installed on the user's computer (or network), client program 73 allows user interface 51 to display folders and files from data management system 60 in two windows as local folders and files in an application drive 53 (shown according to one embodiment as the Z: drive) within directory 118. The first window is a file tree display window 114, which provides a hierarchal view of accessible folders from application drive 53 within directory 118. The second window is a folder contents window 112, which displays the contents of folders selected from file tree display window 114. The directory 118 has a file listing or file tree, which allows for the user to search for a specific file or folder. The user is able to manipulate and use files from folder contents window 112 (e.g., cut, copy, paste, move, drag-and-drop, attach to Windows-based applications, etc.) in substantially the same way the user could manipulate and use their local files. Client program 73 runs in the background as a shell program and does not need to be explicitly “open” for the user to manipulate files from folder contents window 112. Also, the data management system 60 manages all of the files from folder contents window 112 and file tree display window 114 outside of a web browser. Thus, the system does not need a web browser to be open to manipulate or use files from folder contents window 112.

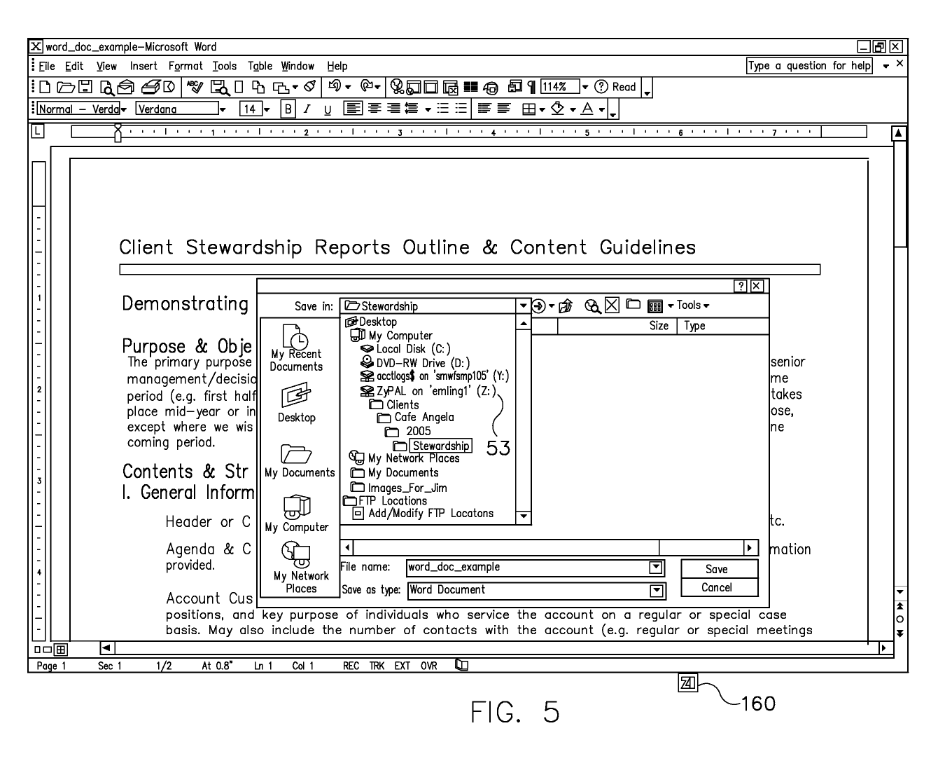

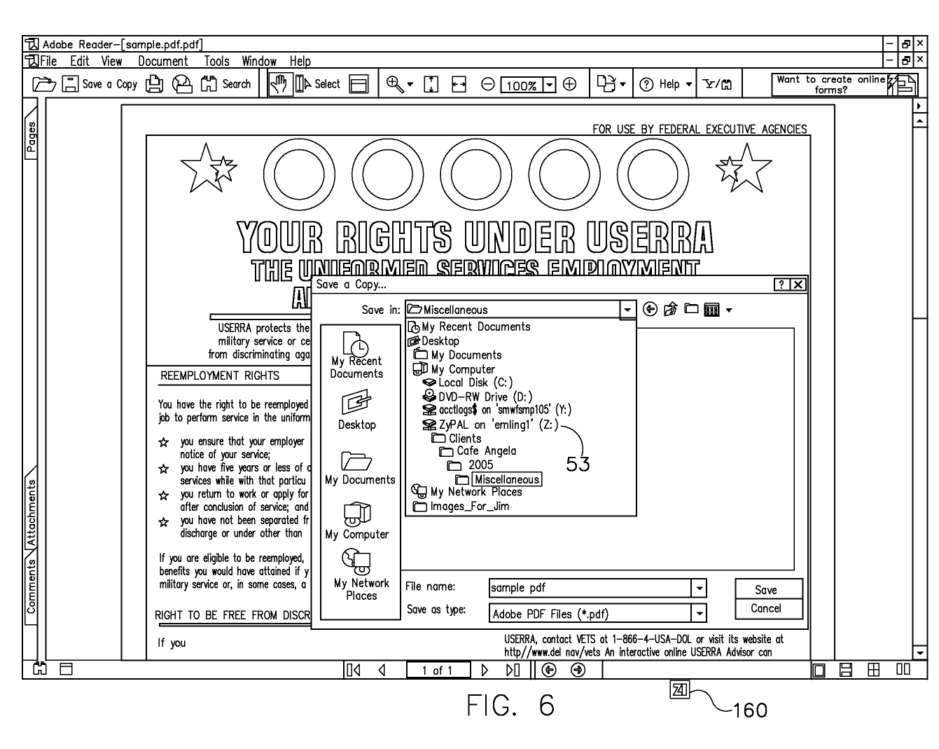

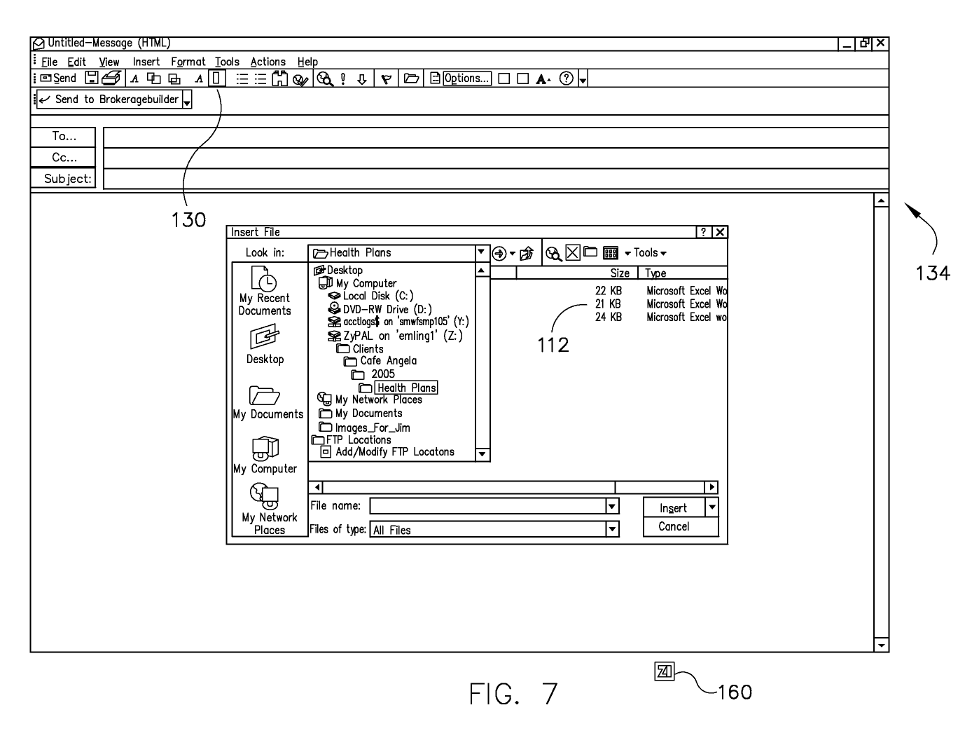

Accordingly, as illustrated in FIGS. 4A-4D, through the use of data management system 60, the system is able to open and revise an application file 55 (see FIG. 4B) by selecting the appropriate folder from file tree display window 114 and selecting application file 55 from folder contents window 112, making the required changes, and then saving application file 55. If the system has a request to add a file to data management system 60, the system saves the document under the appropriate application drive 53. (See FIGS. 5 and 6). Further, if the system has a request to add multiple files (e.g., such as previously existing local files) to data management system 60, the system may be used to select the relevant files and drag them to the appropriate location within application drive 53. Similarly, if system has a request to email application file 55 from data management system 60, the system may be used to attach application file 55 to an email 134 using the same interface procedures required to attach a local file. (See FIG. 7). If the file tree structure of application drive 53 is changed (e.g., by adding a folder, deleting a folder, moving a file from one folder to another folder, etc.) within user interface 51, access tool 70 synchronizes the tree structure within data management system 60 to conform to the user's changes in substantially real time.

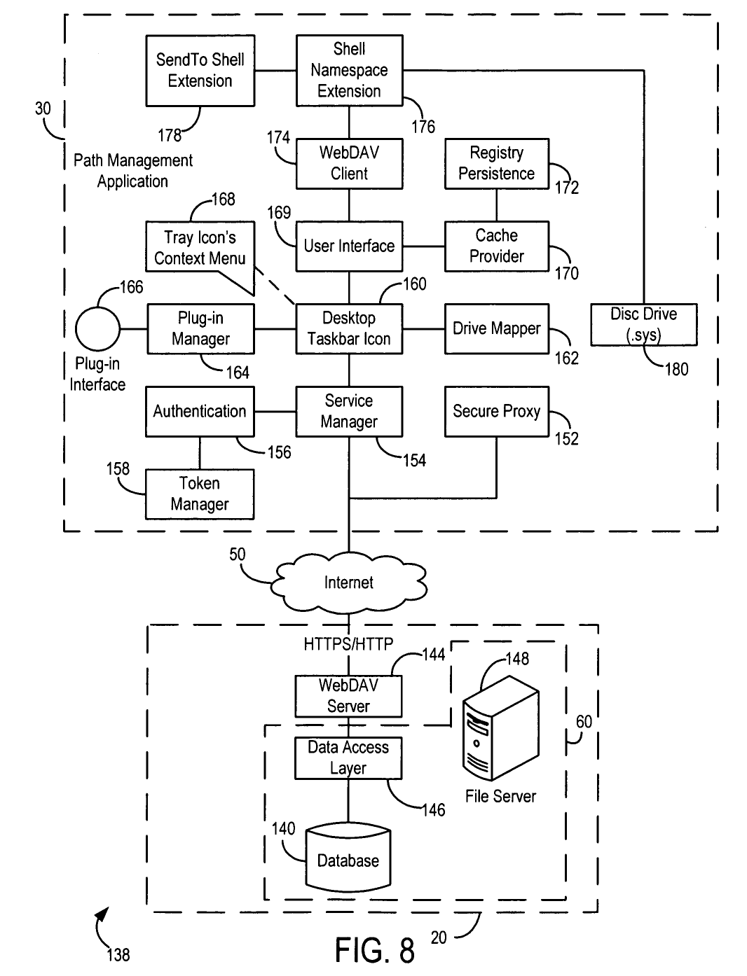

In FIG. 8 a high level system architecture 138 is shown. In one embodiment, the network services system includes a WebDAV server 144 coupled to a file server 148 and a data access layer 146 coupled to database 140. WebDAV server 144 controls access to files stored in user content database 140. Data access layer 146 communicates with database 140 to retrieve, send, index and store files (e.g, application file 55).

Client program 73 (See FIG. 3) has various program code to enable specific functions. According to one embodiment, access tool 70 and client program 73 make use of a combination of WebDAV, XML specifications, NET remoting, and SQL Server 2005 to achieve the functionality described herein. These functions are labeled as secure proxy 152, service manager 154, authentication logic 156, token manager 158, desktop taskbar icon logic 160, drive mapper 162, plug-in manager 164, plug-in interface 166, context menu logic 168, user interface logic 169, cache provider 170, registry persistence logic 172, WebDAV client 174, shell namespace extension logic 176, sendto shell extension logic 178 and disc driver logic 180.

Secure proxy 152 is a tunnel that forwards all requests made over HTTP port 80 to HTTPS port 443. The drive letters are mapped using drive mapper 162 to the local location of http://localhost/files. In one embodiment, secure proxy 152 then tunnels all requests to a secure https site. User interface 51 does not show this transfer being completed. In another embodiment, secure proxy 152 ensures that every user request has been authenticated and that valid network credentials exist. In one embodiment, secure proxy 152 uses a process request method which is configured to avoid any popups of additional login prompts to re-authenticate.

Service manager 154 controls the mapping of an interface to a service implementation and provides for custom configuration of remoting channels which allows a programmer to change the implementation of the service (e.g. moving from a .NET remoting implementation to a SOAP HTTP service implementation) in a transparent fashion to the end user.

Authentication logic 156 (e.g. AuthChecker.cs) is responsible for authenticating the user's login credentials with data management system 60 over HTTPS.NET remoting. Service manager 154 provides the required service interface contract to authentication logic 156. Authentication logic 156 renews the authentication token on a periodic bases by communicating with data access layer 146. In one embodiment, the communication between authentication 156 and data access layer 146 utilizes the “UserDAL.Authenticate” method.

Token manager 158 allows local administrators (e.g. Help desk teams) to reset administrative functions (e.g. reset primary and secondary passwords). Desktop taskbar icon logic 160 provides a persistent image (See FIG. 4A) through which the user accesses service options including help menus. The icon is open by double clicking on the icon, which opens a new instance of Windows Explorer (explorer.exe). Windows Explorer is connected to the mapped application drive via drive mapper 162.

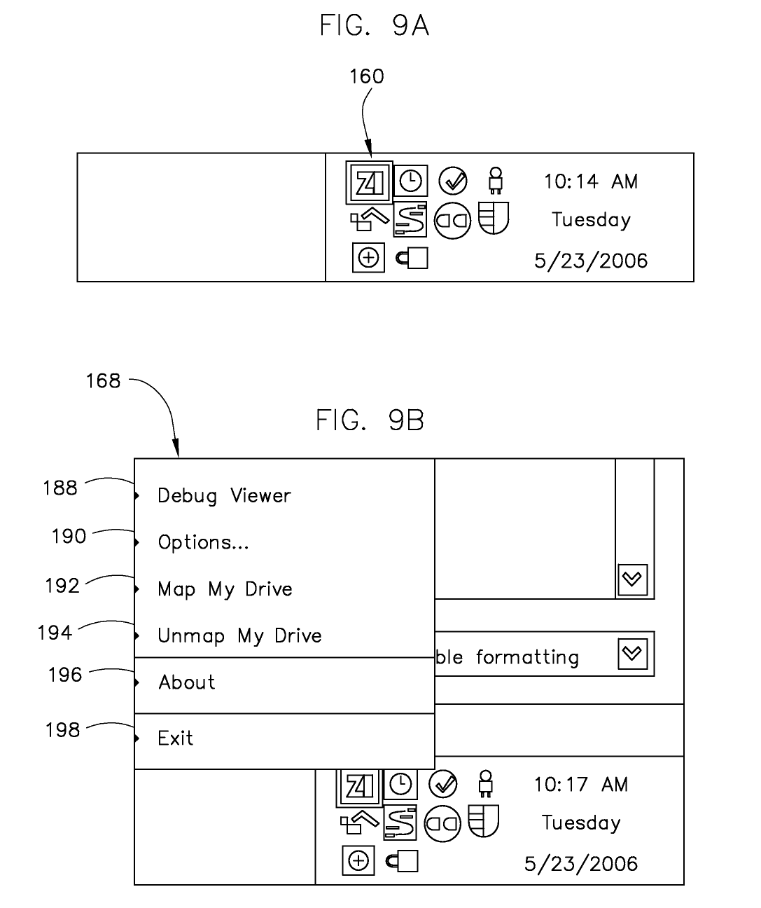

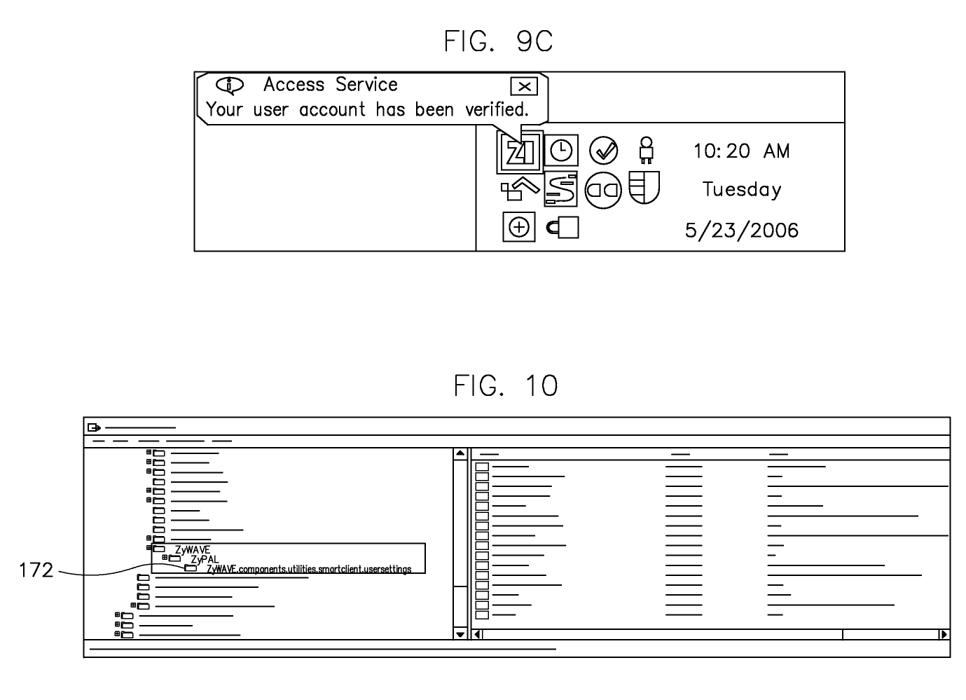

In FIGS. 9A-9C, exemplary embodiments of the desktop taskbar icon are shown. A tray icon's context menu 168 is displayed by right-clicking on desktop taskbar icon 160. A debug viewer 188, options 190, map my drive 192, unmap my drive 194, about 196 and exit 198 are included in the menu options contained in the tray icon's context menu 168. As will be appreciated, other functions may also be displayed in tray icon's context menu 168.

Referring to FIG. 8, the user may utilize drive mapper 162 to select the desired drive letter to be mapped to http://localhost/files. The user selects the desired drive letter; however, sometimes the desired drive letter is already being used and mapped to a different location. In one embodiment, drive mapper 162 iterates through all available (non-mapped) drive letters and choose the next available drive letter.

Plug-in manager 164 validates and loads all plug-ins from data management system 60. In one embodiment, all plug-ins are loaded into separate application domain to ensure that the plug-ins are kept separate from client program 73 which enhances system reliability. Plug-in manager 164 utilizes a plug-in interface 166 device to communicate with the external accessory.

Cache provider 170 is configured to enable a method of marshalling classes transparently to different storage mechanisms. In one embodiment, cache provider 170 could be filecache or a registrycache. The filecache stores data in the files. The registrycache stores data in the registry. The filecache can be provided in either XML or a binary format for backing the cache.

ICashe is the interface implemented by all of the cache backing schemes. Cache is a bridge or façade pattern that hides some of the complexity of interacting with the ICaches. CacheFactory is a factory pattern for the creation of ICaches, which allows for the option of registering ICache providers at runtime. XmlCache is a file based cache that serializes to XML. BinaryCache is a file based cache that serializes to a binary format. RegistryCache is a registry based cache that maps an object to registry entries.

In FIG. 10, the registry persistence 172 stores data that is use for persistent object classes. The persistent objects of client program 73 are stored in the Windows registry. User interface logic 169 interacts with other Windows components to provide aspects of the user interface related to the client program as previously described.

Referring back to FIG. 8, WebDAV client 174 controls access to application files (e.g., application file 55). WebDAV client 174 uses a list of authorized user to determine which users are allowed to collaboratively edit and manage application files (e.g., application file 55).

Shell namespace extension 176 and sendto shell extension 178 integrate client program 73 with Windows Explorer. Shell namespace extension 176 causes the display that Windows Explorer generates to present the file system and other objects to the user to reflect objects (files, folders) associated with client program 73 to be displayed along with other objects, such as disk drive 180. Sendto shell extension 178 integrates with Windows Explorer to respond to changes in directory structure of application drive 53 (e.g., to reflect new files or folders).

According to various alternative and exemplary embodiments, access tool 70 may be configured to enable real-time file collaboration; to enable the “pushing” of content and/or messages directly to the desktop of users, e.g., to launch new products, deliver content, or deliver key messages; to enable real-time instant messaging and/or support tickets; and so on.

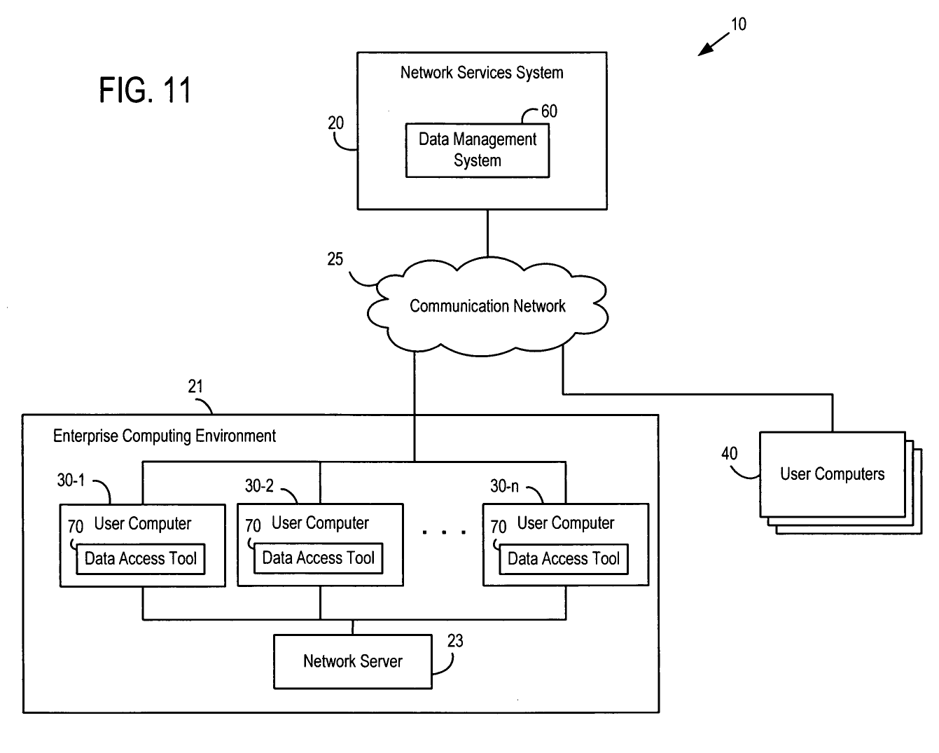

Referring now to FIG. 11, an embodiment of a system 10 is shown. System 10 comprises a network services system 20, user computers 30, and user computers 40. Network services system 20 permits user computers 30 and 40 to access data in data management system 60 through computer network 25. In an exemplary embodiment, an enterprise computing environment 21 is shown. Enterprise computing environment 21 includes a client network server 23, a plurality of user computers 30-1, 30-2 and 30-n, and a plurality of data access tool 70. In an exemplary embodiment, client network server 23 stores data files that are not part of the ASP services. Client network server 23 is configured to store files that are not stored on network services system 20. Plurality of user computers 30-1, 30-2 and 30-n are utilized by individual employees of a single customer of the ASP to access the ASP services, network services system 20 and client network server 23. Plurality of user computers 30-1, 30-2 and 30-n include data access tool 70. Data access tool 70 is configured to work with various software packages (i.e. Visio®, Powerpoint®, Excel®, Access®, any Microsoft® software program and/or other non-Microsoft® software program).

Enterprise computing environment 21 is configured to utilize network services system 20 while not utilizing client network server 23. In an exemplary embodiment, the system may utilize both client network server 23 and network services system 20. This flexibility may create significant cost and technological advantages for a customer of the ASP because the customer may have common access to files by multiple different users in the enterprise while at the same time permitting the files to be accessed by the ASP. The customer may not need or may be able to reduce the size of the customer's client network server 23. In an exemplary embodiment, the customer can reduce their client network server 23 demands because of a reduction in storage or network capacity.

According to one embodiment, data management system built for the insurance brokerage industry, is used. Data management system generates request for proposals (RFPs), proposals, stores client data, and tracks sales and commission data while integrating seamlessly with other applications.

Referring now to FIGS. 12A-12B, FIGS. 12A-12B show data management system's login screens. After the data management system administrator sets up a user account, the user receives an introductory e-mail with their username and a link to the data management system home page. In an exemplary embodiment, the user follows instructions provided on the data management system home page. First, the user clicks on the data management system homepage link provided in the user's introductory e-mail and the user is routed to the data management system homepage. The data management system homepage serves as the main Login screen for the user. Second, in the main Login screen the user clicks on the “Forgot your Password?” box, which routes the user to Forgot Login Information screen 200. In Forgot Login Information screen 200 the user enters their username listed in the introductory email in “Enter User Name” field 220. Third, in Forgot Login Information screen 200 the user clicks on “Get NEW Password” box 210. Fourth, the user clicks on “close” link 230 to close Forgot Login Information screen 200, which returns the user to the main Login screen. Fifth, the user enters their username and new password in the main Login screen. Sixth, the user clicks on the Login box, which routes the user to User Account screen 240. Seventh, in User Account screen 240 the user can create a new password and/or username by selecting “Change Password” and “Change Username” links 250.

Referring now to FIGS. 13A-13B, FIGS. 13A-13B show that in an exemplary embodiment, data management system 60 includes a content generator engine 61 which is configured to create a template 303. The number of templates available in the ASP's template library is limited only by the amount of storage capacity in the ASP's database. Templates 303 created by content generation engine 61 may be customized, stored in template library and distributed as discussed later in this description.

In an exemplary embodiment, template 303, as shown in FIG. 13A, may be customized for the insurance brokerage industry by populating data fields 305. It should be noted that while template 303 finds particular utility in the insurance brokerage industry, the templates in the template library, including template 303, could be designed for other industries and uses. Template 303 is customized by inserting a client data 302 in data fields 305. As shown in FIG. 13B, after inserting client data 302 in data fields 305, a brochure 301 is created based on the merge fields functionality of the system. The merge fields functionality merges data fields 305 and client data 302 in template 303.

In an exemplary embodiment, client data 302 may include the company's name, the company's address, the company's telephone number, the company's facsimile number, the company's web address, the company's logo, the company's slogan, the company's marketing message, a client specific message, a target market specific message, other data, or any combination thereof.

An ASP's client may assign one or more users to the administrative function. These administrators or administrative users may grant access to other users on an as needed basis. An administrative user may also have the ability to set up email functions for users, subscribe to campaigns, upload new templates as needed, and/or create custom merge fields. In an exemplary embodiment, a campaign includes various templates that are sent on a preset schedule to a customer of the client. In another exemplary embodiment, the administrative user may customize client data 302 for a marketing campaign or specific targeted solicitation.

In an exemplary embodiment, access to financial templates is attained by accessing the ASP's portal. In an exemplary embodiment, the ASP's portal may prompt a person for their username and/or password. However, if the user has saved their username and password while logging in during a previous session then the user will be immediately directed to the screen shown in FIG. 14. The user may then choose a use button 304a to select a insurance brokerage industry benefits section 306 or a use button 304b to select a insurance brokerage industry property and casualty edition section 308 as applicable. In an exemplary embodiment, insurance brokerage industry benefits section 306 and insurance brokerage industry property and casualty edition section 308 are part of the ASP's applications

A insurance brokerage industry's benefits edition may contain numerous combinations of template categories. In an exemplary embodiment, a benchmark surveys and statistics category may be created, which provides the user with industry related statistical information. In another exemplary embodiment, an employee communications & education category may be created, which provide industry training to employees utilizing various communication methods. In another exemplary embodiment, a sales tools category may be created, which provides the user a variety of programs to better interact with their customers. In yet another exemplary embodiment, a compliance & plan designs category may be created, which ensure that industry standards and rules are being met and provide the user with a plan to follow. In a further exemplary embodiment, an employer education category may be created, which provides up to date training for employees. The ASP's products, which includes access to a variety of industry related programs; or a wise & well section, which educates the user regarding healthcare consumerism. Template categories in a insurance brokerage industry's property and casualty edition may contain any combination of the following: cost containment (which provides the user with information relevant to helping their clients maintain control of their costs); employee communications (which provides a variety of templates to communicate with clients); print proposals (which provides a means to print proposals for clients); sales concepts (which provides a variety of sales methods and ideas for the user to apply to their client base); loss control (which provides various methods for controlling agency loss for their clients); marketing tools (which allows the user better communication strategies to apply to their clients); studies and surveys (which provides the ASP's products which includes access to a variety of industry related programs); OSHA compliance (which provides detail regarding compliance with the regulations and standards of the federal agency of Occupational Safety and Health Administration's standards); or commercial risk summaries (which provides detailed data on various insurance risks associated with the user's clients).

In an exemplary embodiment, templates may be chosen for customization in a variety of manners. The user may browse for a template, perform a search for a specific template, or select a previously utilized template that has been marked as a favorite. As shown in FIG. 15, a template details page 311, which is a portion of a insurance brokerage industry's application screen may have a prospect button 310, a retain button 312, a renew button 314 and a templates button 316. Prospect button 310 will initiate a prospect wizard, which can be utilized to find templates that are appropriate for attaining new business. Retain button 312 allows the user to select templates that pertain to the retention of current clients, and by selecting renew button 314, a user is directed to templates that are beneficial in the renewal process for clients. By selecting templates button 316, a user may browse all templates available by category.

According to an exemplary embodiment, a user may be taken to template details page 311, once the performance of a search is completed and/or the initiating of a browse option is requested. Template details page 311 includes a thumbnail image of a template selected 318, a template title 320, a fee schedule, and a brief description of a template 322. Fee schedule shows the entity that created template 303 and the fees for usage of template 303. Template details page 311 also includes a template identification number 324 which is a unique number identifying a template, a source identifier 326, which designates the creator of the document, and a return to search results link 328. Further, shown in FIG. 15 are document action buttons which are used to preview or select template 303. A star icon 330 is used to denote template 303 as a favorite. Star icon 330 allows a user to add template 303 to a list of favorite templates. A magnifying glass icon 332 represents a preview, which allows a user to view template 303 with all merge codes available. A basket icon 334 represents selection basket. By selecting basket icon 334, template 303 is added to a selection basket for distribution at a later time.

In another exemplary embodiment, template details page 311 includes a merge fields option 336. Merge fields option 336 allows a user to view which fields may be automatically customized. A template ratings preview 338 is utilized to show a rating of template 303. In an exemplary embodiment, the rating system is on a four star scale and applied to prospect, renewal, and retain categories. Templates 303 in the system are assigned a rating by the ASP, the users, the open platform template provider, or any combination thereof. The user is allowed to assign ratings to custom templates that the user themselves have created. In an exemplary embodiment, a templates popularity section 340 lists the number of times template 303 is used within a time interval (i.e. day, week, month, year, etc.). The usage is tracked by this program and is automatically reported to an end user on a predetermined or customized schedule. In another exemplary embodiment, a related templates link 342 is shown. Related templates links 342 allows the user to go directly to other templates 303 that are related to a current one in terms of template subject matter. Further, template detail page 311 may include a quick search screen 344, an advanced keyword search screen 371, a selection basket screen 346, and a my favorites screen 348. Quick search screen 344 directs the user to an area of the program that is used to search all templates 303 available. Selection basket screen 346 is a function that allows the user to add templates 303 to a list for later customization and distribution. My favorites screen 348 is an option that allows the user to place template 303 on their list of favorites for ease of access in the future.

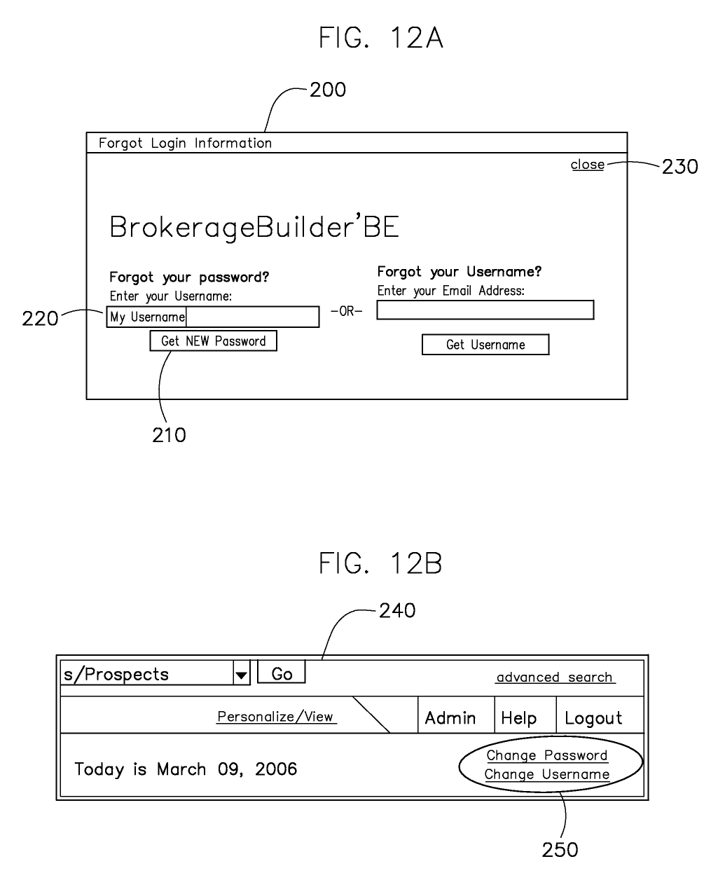

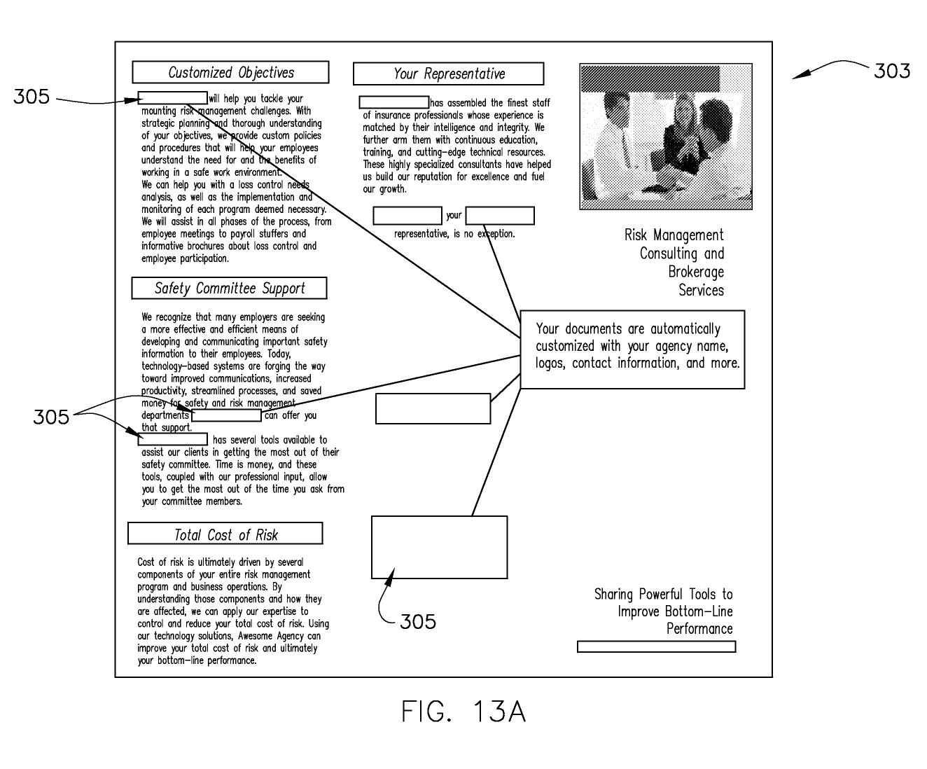

FIG. 16 shows a close up view of quick search screen 344. A quick search function allows a user to select a keywords option 350 or a template number option 352 in a drop down menu 351. In an open text box area 354, a user may enter a keyword to search or template identification number 324 (See FIG. 15). A search is performed once a user selects a go button 356. In FIG. 17, advanced keyword search screen 371 is illustrated, according to an exemplary embodiment. Advanced keyword search screen 371 allows a user to search keywords with an “all” toggle switch 358, an “any” toggle switch 360, or an “exact” toggle switch 362. Additionally, the user may search within a “template groupings” toggle switch 364 and “express campaigns” toggle switch 366. To perform a search on all possible insurance brokerage industry templates, a user may select a “new search” toggle switch 368. To search only within results from a previous search or browse category, a user would select a “within results” toggle switch 370. The user may also select a “search templates” toggle switch 376, a “search by template grouping” toggle switch 364, or a “search by campaign” toggle switch 366. Once keywords have been entered in an open text box 372, a search button 374 may be selected to begin a search. Further, refinement of a search may be achieved by searching again and selecting “within results” toggle switch 370. To start all over and begin a new search, the user would select “new search” toggle switch 368.

Referring to FIG. 18, a my favorites screen 348 is illustrated. My favorites screen 348 may be used if a user wants to annotate specific templates 303 as favorites. First a user locates template 303 they would like to have marked as a favorite. The user selects star icon 330 (FIG. 15) and may choose to select a remove all 388 to clear their list of favorite templates, or a show all 380, which links them to a page that lists all of the selected favorite templates.

In an exemplary embodiment, a user determines which templates 303 they want to distribute to clients. The user may then select the appropriate templates 303 and place them in selection basket 346. To add template 303 to selection basket 346, the user selects basket 334. Template 303 is then added to selection basket 346.

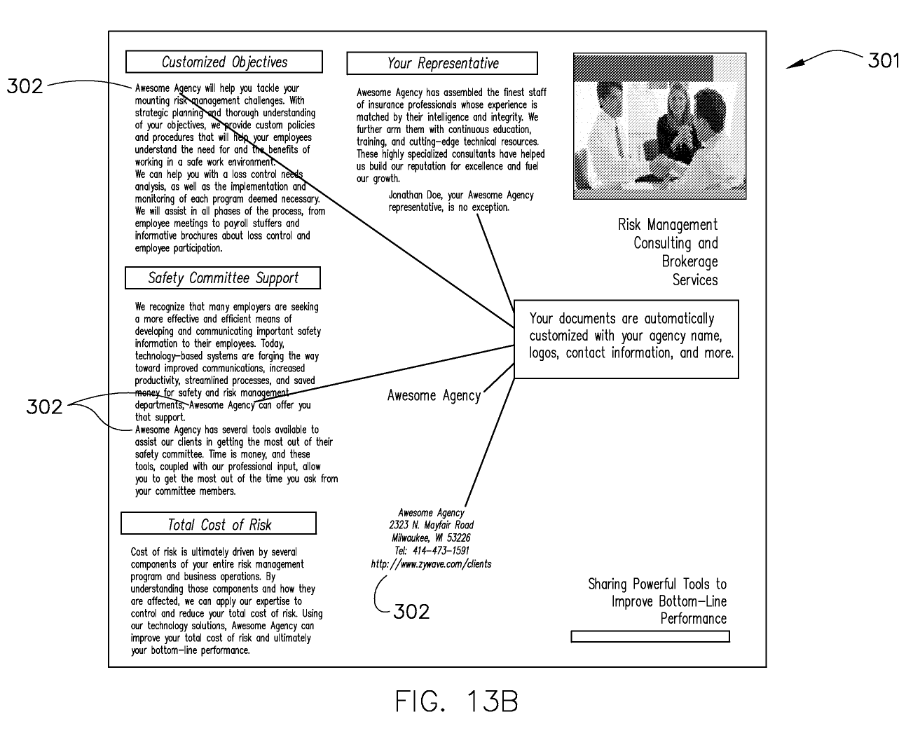

Referring now to FIG. 19, an exemplary embodiment of a close-up view of selection basket 346 is shown. A template list 382 in selection basket 346 is illustrated. A template title 384 is shown with a language letter 386 which designates the language a template is written in. It should be noted that template 303 can be customized for any language desired by the end user. A user may click a remove all button 388 to clear all templates 303 in selection basket 346. Once templates 303 are placed in selection basket 346, templates 303 may be customized and distributed. A user may then select a distribute link 390.

A user has a variety of options for distributing customized documents. In an exemplary embodiment, a user may choose to post a document to the ASP's website. A user's clients may then access a document via an Internet instead of storing the document on a local hard drive or intranet. In an exemplary embodiment the distribution may be an attachment to an email sent to a user's client. In a further embodiment, distribution may be to open and print a completed document or save a document to a hard drive of a user's computer.

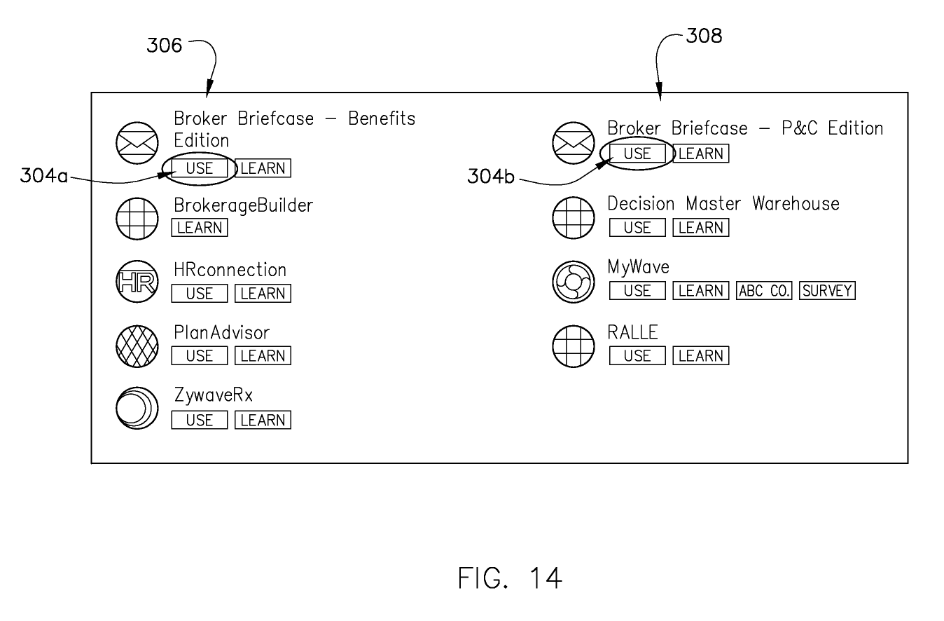

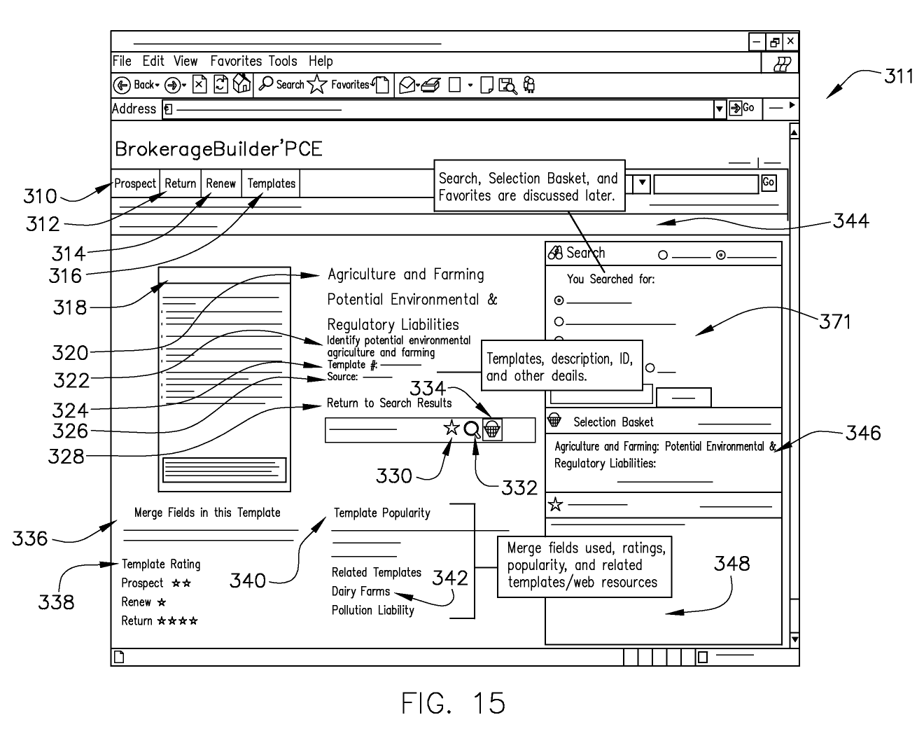

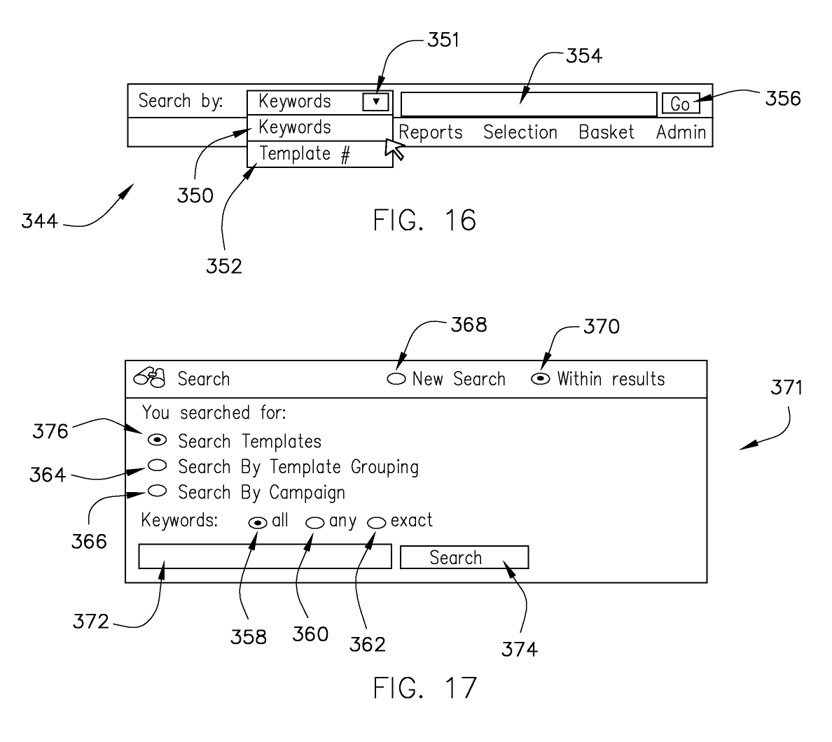

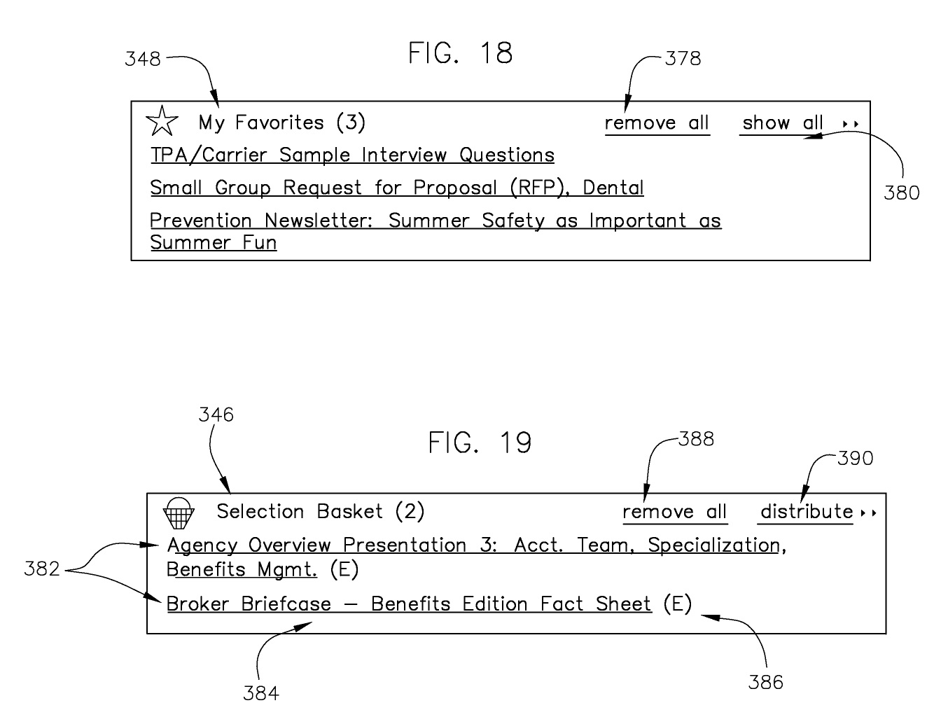

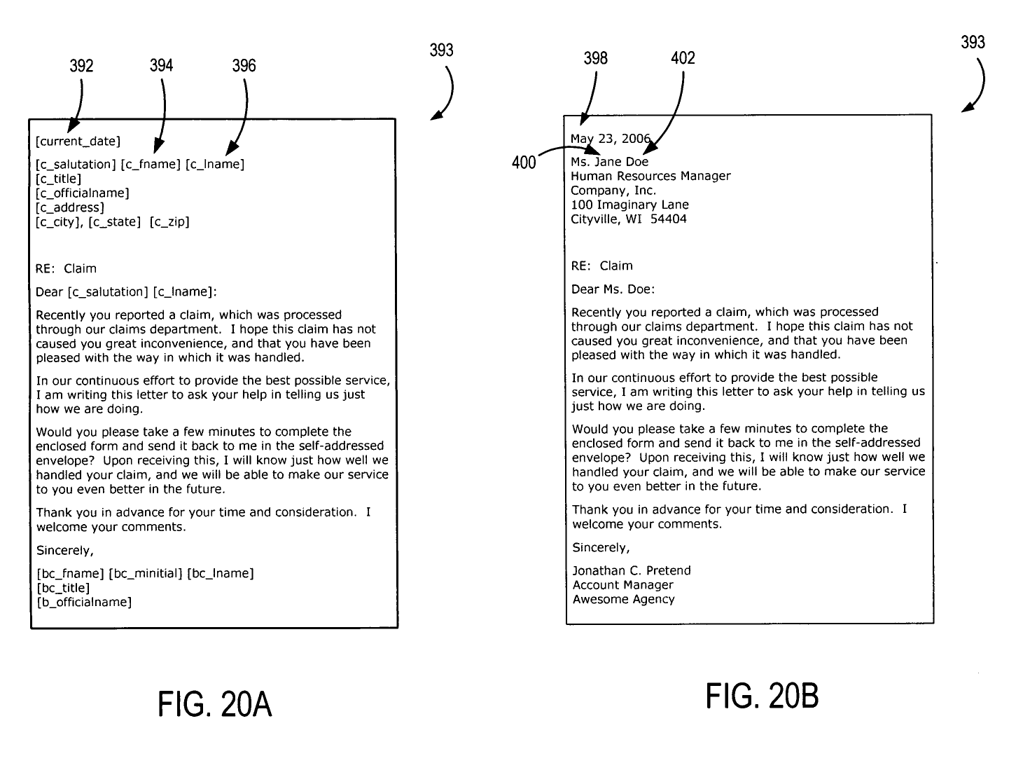

Referring now to FIGS. 20A-20B, a customization process for insurance brokerage industry specific templates is accomplished by using merge fields. FIG. 20A is an exemplary embodiment of a template 393 before the merge fields are populated. Merge fields may be represented in brackets. In an exemplary embodiment, a [current_date] 392 represents the day's current date, a [c_fname] 394 represents a client's first name, and a [c_lname] 396 represents a client's last name. The data for these merge fields is inputted by a user in a setup wizard. When a insurance brokerage industry template software sees the brackets, it looks to a database to find information a user has input for the particular field in brackets. The merge fields are then populated by the insurance brokerage industry software with the correct data. FIG. 20B shows template 393 with merge fields populated. In an exemplary embodiment, a May 23, 2006 date 398 has replaced [current_date] 392 in FIG. 20A. Likewise, a Jane 400 has replaced [c_fname] 394 and a Doe 402 has replaced [c_lname] 396 in FIG. 20A.

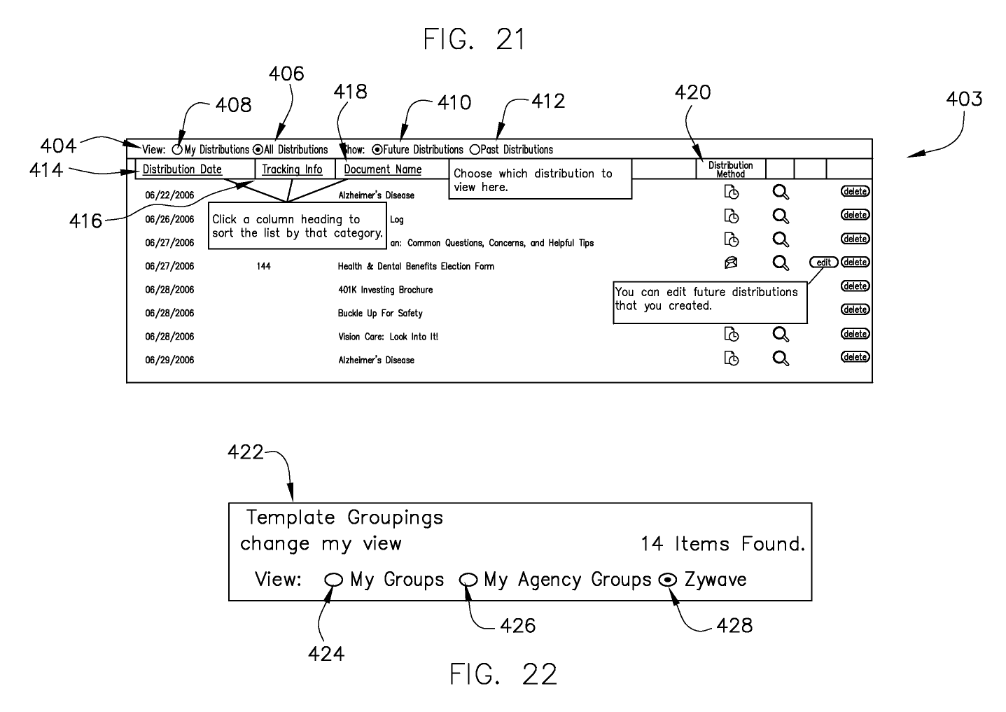

In FIG. 21, an exemplary embodiment of a distribution calendar 403 is shown. Customized template 393 may be distributed to clients. After distributing template 393, a user may choose to track the distribution with distribution calendar 403. A view option 404 allows a user to choose between an “all distributions” toggle switch 406 or a “my distributions” toggle switch 408, which are user created distributions. A show option 405 allows a user to choose between a “future distributions” toggle switch 410 to view those documents that have been prepared but not yet shared with clients, or a “past distributions” toggle switch 412. “Past distributions” toggle switch 412 shows documents that have already been shared with clients. In an exemplary embodiment, information in distribution calendar 403 may be divided into any combination of the following categories: a distribution date category 414, a tracking info category 416, document name category 418, and distribution method category 420. It should be noted that each category may be sorted by any information contained within the category.

A user may group templates 393 so that a standard set of customized templates 393 exist for any number of given clients. In an exemplary embodiment, a close up view of a template groupings provision 422, is shown in FIG. 22. The user may select a “my groups” toggle switch 424 to view template groupings, which were created by the user, or select a “my agency groups” toggle switch 426 to view template groupings that a user's agency has created, or select an ASP toggle switch 428 to view preset template grouping created by an ASP. Once a user determines a group of templates 393 they wish to use, they may put them in selection basket 346, customize, and distribute as previously described.

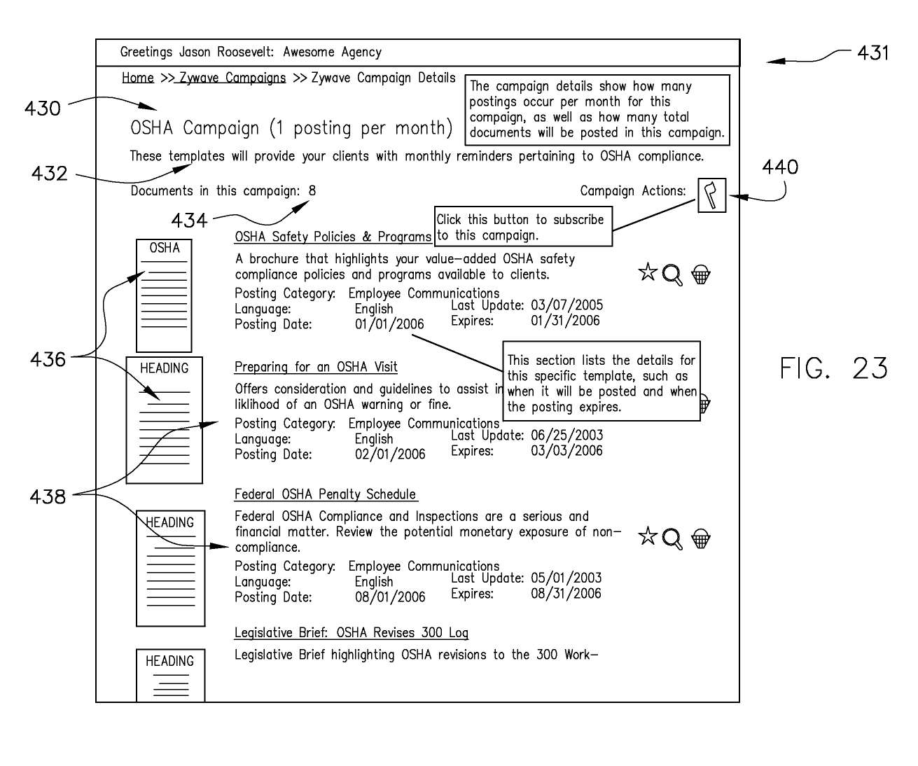

In an exemplary embodiment, a user may choose to provide a customized set of templates 393 to their clients on a preset schedule, or an express campaign. In an exemplary embodiment, templates 393 and schedule are chosen by the ASP, the open platform template provider, the end user, the client, or any combination thereof. Administrators or administrative users of a insurance brokerage industry software have authorization to subscribe to or cancel express campaigns. A user views a list of available express campaigns by subject matter and selects the express campaign they wish to utilize. Once one or more express campaigns are selected, the express campaigns may be made available to other users within an agency. In FIG. 23 an exemplary embodiment of an express campaigns 431 is illustrated. Information presented regarding express campaign 431 may be any combination of the following: a title 430; an explanation of a campaign 432; and a number of documents contained within a campaign 434. To obtain information regarding express campaign 431, a user may then choose a view a document icon 436 with a document details section 438. A red flag 440 is used to denote a user's subscription to express campaign 431.

In an exemplary embodiment, users of insurance brokerage industry software have many customization options available: editing existing templates 393 for a user's agency content; creating new templates 393 that may be uploaded for use by the user's agency; and/or creating various reports regarding available template 393 usage information.

In an exemplary embodiment, the ASP provides the architecture for an open platform template providers to create completely customizable templates. The open platform template providers may be individual experts in a particular field, companies specializing in a particular area (i.e. dental, health, life), individuals with expertise in a particular industry, companies specializing in a particular industry (i.e. law firm, automotive companies, universities) or any combination thereof. In will be appreciated by those skilled in the art that there are numerous individuals or companies that can provide valuable insight to clients and would therefore be a candidate to become an open platform template providers.

The open platform template providers may customize everything from the look and feel to the types of data fields included in template 393. In an exemplary embodiment, the data elements used to create reports (e.g., brochures, documents, letters, invoices, etc.) from templates 393 are divided into three main sections including: a data category; a data view; and a data field. The data category is the most general data element, and the open platform template provider is allowed one data category per main report. In an exemplary embodiment, more than one data category may be used with a sub-report feature. The data view is a sub-category of the data category, and a data category may contain multiple data views. Finally, the data field is an individual type of data item found in each data view, and the data view may contain multiple data fields (e.g., account name, address, city, state, zip, phone number, etc.). The data category and data view elements narrow the pool of data from which the report can be generated and the data field element contains the specific information from which template 393 is populated to create a report.

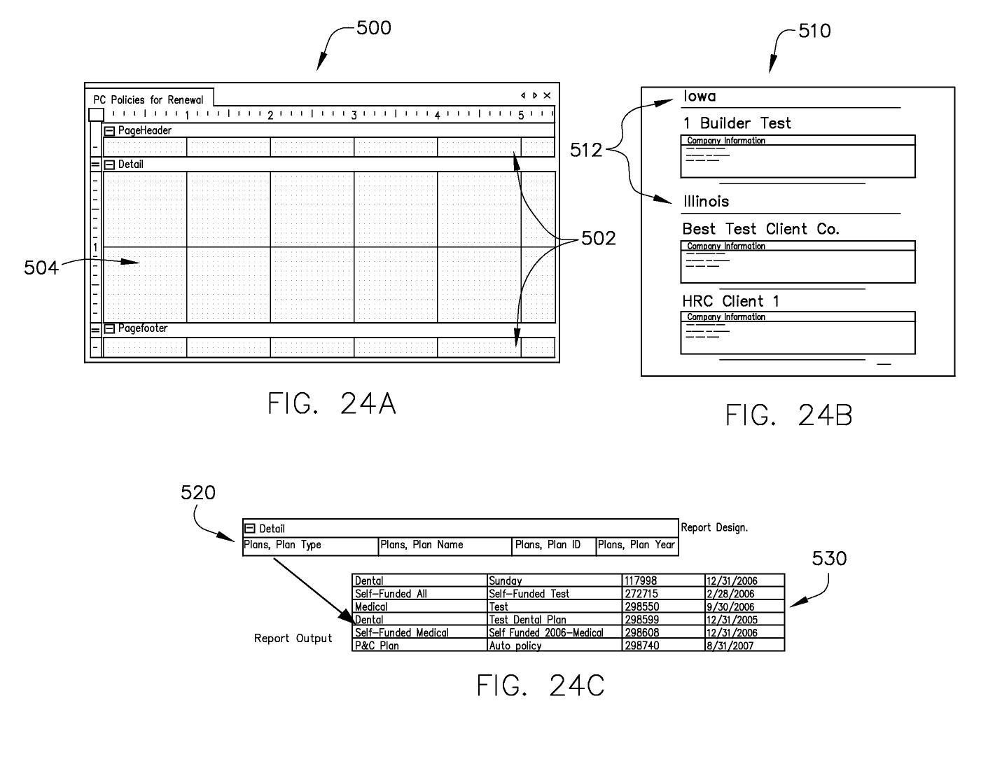

Referring to FIGS. 24A-24C, in an exemplary embodiment, the ASP provides a design window 500 where the open platform template provider creates customized template 393. Design window 500, may be segregated into numerous sections. FIG. 24A shows design window 500 segregated into a page header/footer section 502 and a details section 504. In an exemplary embodiment, several other sections could be added including: a report header/footer section; a group header/footer section; and a sub-report section. In the report header/footer section the open platform template provider can enter information to be included at the beginning and end of the reports produced by template 393. In page header/footer section 502, the open platform template provider can enter information to be displayed on the top and bottom of each page, respectively. In the group header/footer section the open platform template provider can enter headers and footers for each group created within a report. In details section 504, the open platform template provider either manually enters detailed information or selects the associated fields in this section that are filled in from an external data sources, such as a database. Finally, in the sub-report section the open platform template provider may embed a report within another report so that the sub-report can access a data category that is different from the data category accessed by the report. FIG. 24B shows a sample report 510 that groups the contents of the report by state. Sample report 510 contains state names 512 as group headers where the contents of each group corresponds to state names 512. FIG. 24C shows a sample detail design 520 that would be located in detailed design section 504 and a corresponding sample detail output 530. Sample detail output 530 shows the report that would be generated by template 393.

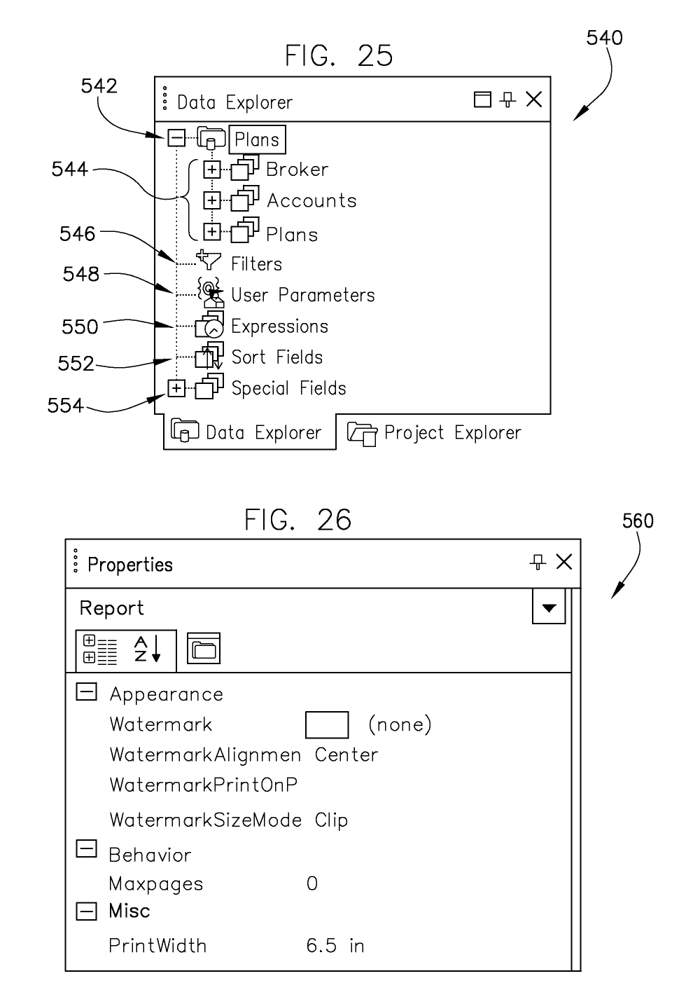

After starting with a blank template the open platform template provider begins by adding various items (e.g., images, text, data fields, etc.) and objects (e.g., label, text, images, lines, etc.) into the sections. In many instances the open platform template provider will want objects to be static (unchanging) so that they appear the same with every use of template 393. The open platform template provider may also add dynamic (changing) items to template 393 that will change based on the information in found in a referenced data source (e.g., database, user input, formulas or expressions, application settings, data from other ASP applications, data from applications external to the ASP, etc.). Referring to FIG. 25, a data explorer window 540 gives the open platform template provider access to all the different types of data that can be used in template 393. Data Explorer window 540 shows a open platform template provider selected data category 542 which contains a plurality of data views 544. The open platform template provider can drill down into the plurality of data views 544 to access the data fields. Data explorer window 540 gives the open platform template provider access to a filters item 546, an open platform template provider parameters item 548, an expressions item 550, a sort fields item 552, and a special fields item 554. Filters item 546 is configured to allow the open platform template provider to limit the data in the report based on one or more criteria. Open platform template provider parameter item 548 is configured to allow the recipient of the report to limit the data based on one or more criteria defined by the open platform template provider. Expressions item 550 is configured to allow the open platform template provider to manipulate text and numeric data fields to achieve a desired output on a report. Sort fields item 552 is configured to allow the open platform template provider to sort the report by any of the fields that are used in the report. Special fields item 554 is configured to allow the open platform template provider to include items that are not directly tied to the data in the report including the following special fields:

| Field | Description |
|---|---|
| Current Date | Inserts the date that the report was generated in mm/dd/yyyy |
| | format. |
| Current Date Time | Inserts the date and time that the report was generated in |
| | mm/dd/yyyy HH:MM AM/PM format. |
| Current Time | Inserts the time that the report was generated in HH:MM AM/PM |
| | format. |
| Report Name | Inserts the name of the report as it was entered when the |
| | report was created or renamed. |
| Last Modified Date | Inserts the date that this report was last saved in mm/dd/yyyy. |
| Last Modified Date | Inserts the date and time that the report was last saved in |
| Time | mm/dd/yyyy HH:MM AM/PM format. |
| Last Modified Time | Inserts the date and time that the report was last saved in |
| | HH:MM AM/PM format. |
| Running Page Number | Inserts a page number for the current page in the report. |
| Running Page Of Total | Inserts the page number of the current page and the total |
| Pages | number of pages in the report (such as 2/15). |
| Total pages | Inserts the number representing the number of pages in the |
| | report. |

A toolbox window is configured to give the open platform template provider access to tools and objects that can be inserted into template 393. The objects accessible through the toolbox are static elements, such as static text, images, lines, etc. The following is a list of the tools that are available in the toolbox window:

| Tool | Description |
|---|---|
| Pointer | Use this tool when working in the report designer window. You use the |
| | pointer to select and move objects on the report designer window. |
| Label | Use this tool to create a basic, static text label. For example, if you |
| | create a report that's broken into columns, you might use a Label as the |
| | header for a column or row. |
| Rich Text | Use this tool to insert more fully-formatted text into your report. In fact, |
| | you can create a rich-text format file (.rtf) in Microsoft ® Word and |
| | upload it directly into this tool. |
| Check box | Use this tool if you want to create a form in a printed report for users to |
| | fill out. |
| Line | Use this tool to insert a line into your report. You may use this line to |
| | separate sections of a report, for example. |
| Shape | Use this tool to draw a rectangle, rounded rectangle, or ellipse on your |
| | report. This is used most often to draw a border around another element |
| | in the report. |
| Image | Use this tool to insert an image into your report, such as a company |
| | logo. |
| Pagebreak | Use this tool to insert a manual page break into your report. For |
| | example, if you want each account's information on its own page, you |
| | would insert a pagebreak object in after the account information as you |
| | design the report. |
| Subreport | Use this tool to insert a report within your report. For example, if you |
| | have an Account information report, you may want to insert an Account |
| | Contact sub-report within it. |

Referring to FIG. 26, a properties window 560 is configured to allow the open platform template provider to view and modify the properties of a particular item or object when that item or object is selected. Each type of object or item has different properties and most properties may be changed manually within properties window 560. However, some properties may change automatically based on other actions taken by the open platform template provider. In these exemplary embodiments, these tools are customizable by the open platform template provider and supported by the ASP's platform. The ASP's platform supports these template 393 during development and after uploading to the ASP's system.

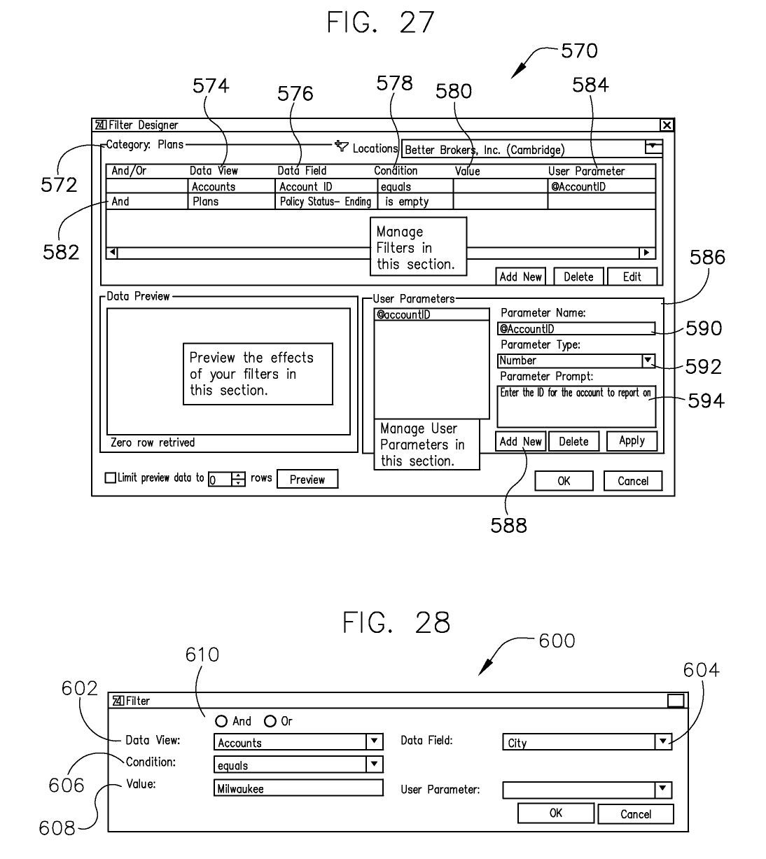

Referring to FIG. 27, the ASP provides a filter designer window 570 accessible from data explorer window 540 by selecting either filters item 546 or open platform template provider parameters item 548. By default, reports will include all records for the data view selected by the open platform template provider. However, in many cases, the open platform template provider may not want a report to include all records from the open platform template provider's data. Instead, the open platform template provider may want to limit the results based on certain criteria. In filter design window 570, the open platform template provider can create filters or set up open platform template provider parameters for the data view chosen and limit the data for the report based on one or more criteria (e.g., state, city, specific recipient, etc.). FIG. 27 shows a category section 572 where the plans data category has previously been associated with the report to be generated. Category section 572 provides a data view heading 574, which shows all the data views within the plans data category for which filters have been created. In this case, the plans data category has two data views under data view heading 574 with filters, an accounts data view and a plans data view. Category section 572 provides a data field heading 576, which shows the particular data field whereon conditions will be placed for purposes of filtering. Category section 572 provides a condition heading 578 and a value heading 580. Condition heading 578 shows the condition set on the selected data field and value heading 580 shows the value associated with the condition if applicable. For example, FIG. 28 shows a filter setup window 600 where the open platform template provider selects a filter data view 602 from the list of available data views. The open platform template provider then selects a filter data field 604 from the list of available data fields within the selected data view. The open platform template provider then selects a filter condition 606 and enters a filter value 608. In FIG. 28 the open platform template provider has selected the accounts data view, the city data field and set a condition and value so that only the accounts that are located in Milwaukee will be used in the report. Therefore, accounts located in Chicago, Madison or any city other than Milwaukee will not be used. An And/Or feature 610 may be used to designate whether the filter will be conjunctive (And) or disjunctive (Or) in relation to any other filters defined for a particular category. Category section 572 provides an And/Or heading 582 to identify whether the filter has been set to combine conjunctively or disjunctively. Category section 572 provides a open platform template provider parameter heading 584 which displays the open platform template provider parameters associated with a particular filter.

The open platform template provider may setup open platform template provider parameters so that the recipients, or end users, of the report may dynamically narrow the results within the data associated with the report. In filter design window 570 of FIG. 27, the open platform template provider can create or edit open platform template provider parameters in open platform template provider parameter section 586. To create a new open platform template provider parameter the open platform template provider selects an add new button 588, enters a name for the new open platform template provider parameter in a parameter name field 590 and selects the parameter type in a parameter type list 592. The types of parameters available in parameter type list 592 might include string, date, number and boolean. The open platform template provider may also enter a statement or question in a parameter prompt box 594 that solicits a response from the recipient, or end user, of the report. For example, the open platform template provider might ask the recipient, or end user, to “please enter a two letter state abbreviation” so that the report returns data relating to that particular state. After reviewing, printing or saving the generated report for the particular state selected, the recipient may select other states to generate state specific reports. When setting up a filter for a report, the open platform template provider associates the filter with one or more open platform template provider parameter. After the filter is set up for a report, the recipient selects or enters the parameter values to generate a report. For example, the recipient could generate a report that returns accounts for a given state. This parameter might prompt a recipient by saying, “please enter the two-letter state abbreviation for the state you want to report on.” When the recipient enters a state, only records from that state are returned. The parameters feature allows a recipient, or end user, to dynamically filter the content within the data view by state rather than creating a separate template for each state. The parameters feature is most often used as a way to control filters or allow a recipient or end user to enter some dynamic text into a report.

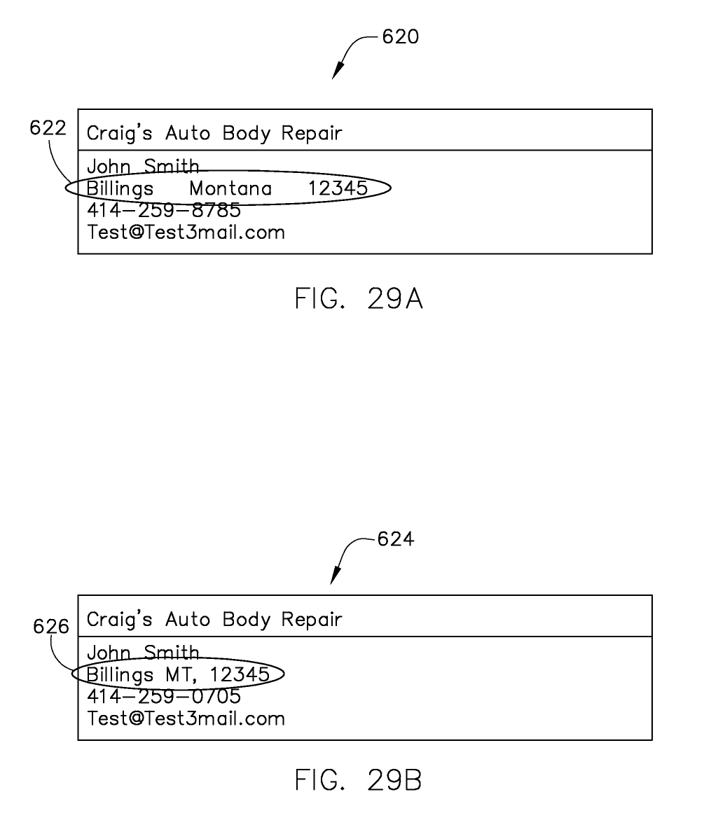

The open platform template provider may use expressions to combine or perform calculations on fields. In FIG. 29A, account contact information window 620 provides information such as the name, address, phone number and email address of the contact for that particular account. In account contact information window 620 the open platform template provider created an address line 622 by placing the city, state and zip fields next to one another on the same line. However, when the open platform template provider places the city, state and zip fields on one line, the open platform template provider will be unable to fully account for the differing lengths of these fields. The open platform template provider might attempt to guess at the appropriate size of each field, but is likely to end up with relatively large gaps between fields (e.g., large gaps between the city, state and zip text). The open platform template provider may eliminate these gaps by creating an expression that combines the city, state and zip fields to create a single field with only a single space between each item (city, state and zip). In FIG. 29B, account contact information window 624 provides an address line 626 that the open platform template provider created using an expression to combine the city, state and zip fields into one field. By using an expression the open platform template provider eliminated the large gaps that existed in address line 622.

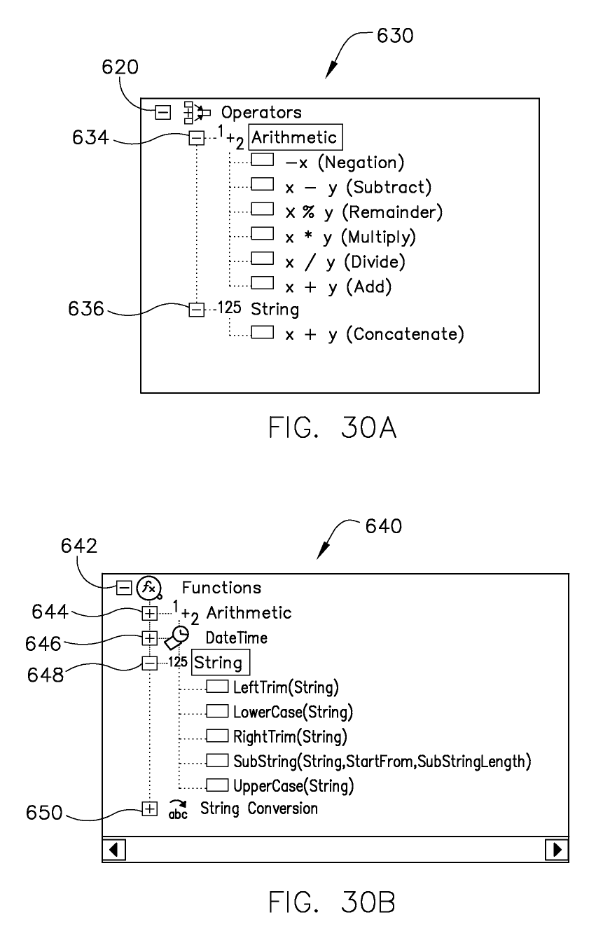

In an exemplary embodiment, the ASP provides an expression editor window where the open platform template provider may create and edit expressions. The expression editor window includes a list of available operators and functions that can be used to create expressions. FIG. 30A shows an operator section 630 which contains an operator list 632. Operator list 632 contains an arithmetic operator list 634 and a string operator list 636. Arithmetic operator list 634 includes operations such as addition, subtraction, multiplication, divisions, etc. String operator list 636 includes string combination (concatenation). FIG. 30B shows a function section 640 which contains a functions list 642. Function list 642 contains an arithmetic function list 644, a date function list 646, a string function list 648 and a string conversion list 650.

The merge fields functionality of the system provided by the ASP allows the open platform template provider to automatically merge the data located in specified data fields (specified by data category, data view, and data field) with the template fields. More specifically, the open platform template provider may associates a data source (e.g., database, end-user input, formulas or expressions, application settings, data from other ASP applications, data from applications external to the ASP, etc.) containing information about, or intended for, multiple recipients and merge the data located in the data source with the template fields to generate a report that is customized for each recipient. The merge feature of the ASP system used in conjunction with a data source to automatically generate reports, eliminates the need to enter data by hand into the template fields. The merge feature may also incorporate other data not necessarily located in the data source, such as the current date, open platform template provider's first and last name, open platform template provider's company name, etc. This data might be provided by the ASP system (e.g., current date), by the open platform template provider's account settings (open platform template provider's first and last name, and open platform template provider's company name, etc.), by the open platform template provider entering the information in a template wizard, or by manually adjusting the settings for that particular merge session.

In an exemplary embodiment, once template 393 is created the open platform template provider may set up a distribution where the reports are automatically generated and distributed to chosen recipients without any additional intervention from the open platform template provider. The distribution schedule may be set up to distribute reports on a periodic basis, such as, daily, weekly, monthly, yearly, etc. The open platform template provider has control over a number of recurrence options to further customize the distribution, including the following:

| Recurrence | Option | Description |
|---|---|---|
| Daily | Every X day(s) | Choose this option to set the number of days between |
| | | scheduled distributions. 1 indicates every day, 2 every |
| | | other day, and so on. |
| | Every weekday | Choose this option to run the report on every weekday |
| | | (Monday through Friday). |
| Weekly | Recur every X | Set the number of weeks between scheduled |
| | week(s) on | distributions. 1 indicates that it will occur every week, 2 |
| | | every other week, and so on. |
| | Select one or | Choose the days that the schedule will be distributed on. |
| | more week | |
| | days | |
| Monthly | Day X of every | Choose this option if you want the distribution to occur on |
| | Y month | a specifically-numbered day. For example, the 15th of |
| | | every third month. |
| | | Day X specifies a particular day of the month that the |
| | | report will be distributed. Every Y month(s) indicates |
| | | the number of months between each distribution. 1 |
| | | indicates every month, 2 every-other month, and so on. |
| | The X Y of | Choose this option if you want the distribution to occur on |
| | every Z | a particular day of the week. For example, the last Friday |
| | month(s) | of every second month. |
| | | X indicates the relative week of the month in which you |
| | | want the distribution to occur, such as first, second, third, |
| | | fourth, or last. |
| | | Y indicates the day of the week that you want the |
| | | distribution to occur. |
| | | Z indicates the number of months between each |
| | | distribution. 1 indicates every month, 2 every-other |
| | | month, and so on. |
| Yearly | Every X Y | Choose this option if you want the distribution to occur |
| | | once a year on a particular numbered day of a given |
| | | month. (Such as every January 1st.) |
| | | X indicates the month that you want the distribution to |
| | | occur. Y indicates the day of the month. |
| | The X Y of Z | Choose this option if you want the distribution to occur |
| | | once a year on a particular day of the week in a given |
| | | month. For example, the last Friday in January. |
| | | X indicates the week that the distribution will occur. Y |
| | | indicates the day of the week. Z indicates the month. |

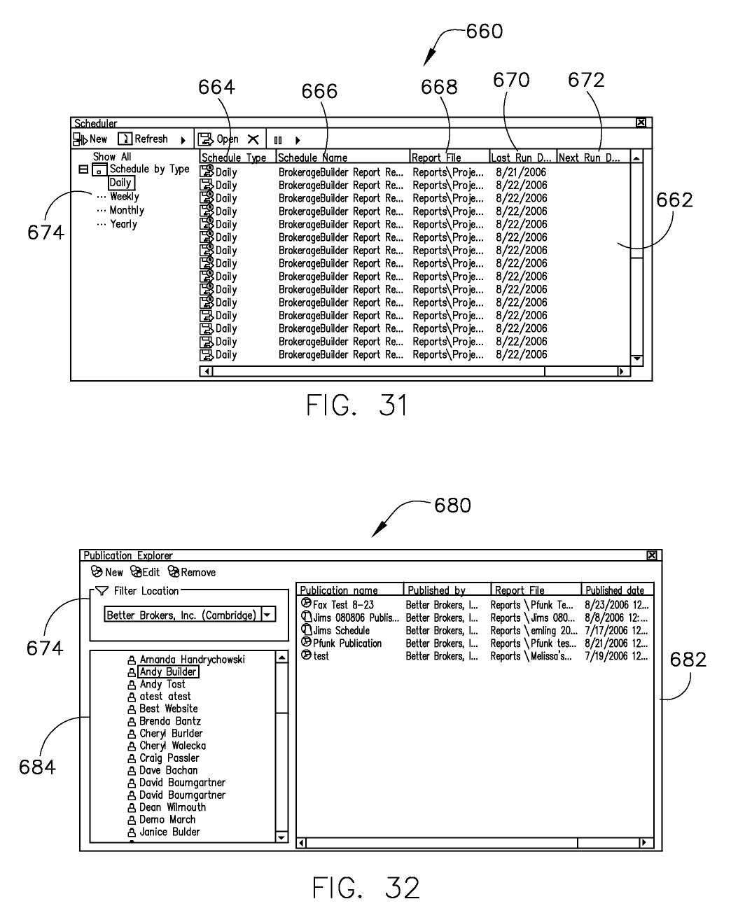

The reports may be delivered to recipients as email attachments in whichever format the open platform template provider chooses. The scheduled reports are generated immediately prior to distribution, therefore, the data in the reports is current. In an exemplary embodiment, the ASP provides the open platform template provider with a schedule explorer window 660 in FIG. 31 where the open platform template provider may create and manage distribution schedules. From schedule explorer window 660 the open platform template provider may review the list of scheduled reports, pause and start a scheduled distribution, schedule a report for distribution, edit an existing schedule, delete an existing schedule, and distribute a report on-demand. Schedule explorer window 660 displays the schedules in a schedule explorer list 662 that may include informational headings such as, a schedule type heading 664, a schedule name heading 666, a report file heading 668, a last run date heading 670, a next run date heading 672, an author heading, etc. The list of schedules may be sorted by any of the headings (e.g., sort by schedule name heading 666). In schedule explorer window 660 the open platform template provider may filter the list of schedules by showing only the schedules that meet the selected criteria. For example, FIG. 31 shows a filter by type section 674 that allows the open platform template provider to display in schedule explorer list 662 only those lists that corresponding to the schedule type selected.

When creating a schedule, the open platform template provider must specify a variety of information about the scheduled distribution, such as, the report to distribute, report name, report format, schedule recurrence, list of recipients, distribution email, and confirm schedule details. In an exemplary embodiment the ASP provides a schedule wizard to assist the open platform template provider in creating a schedule. The wizard displays a primary information window where the open platform template provider enters a descriptive schedule name. The open platform template provider is then prompted to select a report file and is given the opportunity to browse to the location of the desired report file. After selecting the report file, the open platform template provider is then prompted to select the desire format, which includes formats such as, Protable Document Format (PDF), Microsoft® Excel® Workbook (XLS), Tagged Image File Format (TIFF), HTML, Comma Separated File (CSV), etc. In an exemplary embodiment, template 393 could be permanently stored in the template library. In another exemplary embodiment, the open platform template provider is then prompted to select the schedule type, which is the frequency of recurrence for report distribution. The open platform template provider selects a recurrence patter, such as, daily, weekly, monthly, or yearly. Once the pattern is selected the open platform template provider selects the options for the specific recurrence (e.g., if weekly is chosen the open platform template provider sets how many weeks the schedule occurs and on which days it is distributed). The open platform template provider then selects a start date and has the option of also selecting an end date. The open platform template provider is then prompted to identify the recipients of the schedule distribution. The recipients may be grouped in a number of different ways, such as, location, plan status, plan type, or any other criteria. Once the list of recipients is generated the open platform template provider is prompted to configure email settings. The open platform template provider may configure the email settings so that recipients are blind carbon copied (Bcc) in the email so that a recipient will not see the other recipients of the message. The open platform template provider may enter the desire subject line and email body to be sent to each recipient. Once a distribution schedule is created the open platform template provider may revisit the settings to make any necessary changes. If a report is scheduled for distribution sometime in the future, but the open platform template provider wishes to distribute an updated copy now, then the open platform template provider may run the schedule in an on-demand fashion. The on-demand feature puts the request for distribution at the top of the distribution queue so that it will be generated and distributed as soon as possible. The open platform template provider may select whether there is a fee for utilizing template 393 or whether template 393 usage is free.

In addition to scheduling reports, the open platform template provider may distribute reports by using a publishing feature provided by the ASP. The publishing feature is ideally suited for situations where reports are needed on-demand at irregular intervals. In these types of situations, running a scheduled report in-demand can be cumbersome. Using the publishing feature the open platform template provider does not actually create the report output for each intended recipient. Instead, the open platform template provider creates a link through which the intended recipient can generate the report when needed. When the intended recipient selects the link, they must fill out certain parameters that are set up for the report by the open platform template provider, such as, reporting period, other filters, or payment mechanisms. The report is then placed in the queue and distributed to the intended recipient via email. The report may also be distributed in other ways to the recipient, for example, the report could be posted to the recipients online account, it could be appear in a web browser on the recipients computer shortly after the recipient requests the report (i.e., the recipient would be prompted to wait for the report being generated), the report could appear on the recipients computer using an application program, such as, Adobe® or Microsoft® Word®, after the recipient request the report, or the report could be downloaded to the recipients computer shortly after the request. To assist the open platform template provider in setting up and managing published reports, the ASP provides a publication explorer window 680 in FIG. 32 where the open platform template provider may create and manage published reports. In publication explorer window 680 the open platform template provider may view a list of currently published reports in a publication list 682, filter publication list 682, create a new report publication, edit an existing publication, remove a publication, etc. Publication list 682 includes all publications that have been set up for the recipients in publication recipient list 684. If an individual recipient has been selected from publication recipient list 682 then publication list 680 will only contain publications for that particular recipient. Publication recipient list 682 contains all of the recipients that are members of a location selected in filter location section 686. In filter location section 686 the open platform template provider may select a single filter location or multiple filter locations to include in publication recipient list 682.

To publish a report, the open platform template provider defines a new publication in publication explorer window 680. A publication is connected to a single report; however, a single report can be created for a number of intended recipients. Additionally, the open platform template provider may have multiple publications that all refer to the same report. The open platform template provider may want to do this if the open platform template provider wants to have different expiration dates for different recipients. For example, the open platform template provider might give one set of recipients unlimited access to a report, but want the report to expire after one month for another set of end-users. To create a publication, the ASP provides a publish report wizard. The publish report wizard prompts the open platform template provider to enter a descriptive name for the publication. The open platform template provider is then prompted to select a report file and is given the opportunity to browse to the location of the desired report file. After selecting the report file, the open platform template provider may select an expiration date of the publication. The open platform template provider is then prompted to identify the recipients of the publication. The recipients may be grouped in a number of different ways, such as, by location, by agency, by plan status, plan type, or any other criteria. After the publication is created the open platform template provider may edit its settings and properties. Once a publication expires, it is not automatically removed from the publication explorer list. It can be updated and reused by the open platform template provider or the open platform template provider may chose to manually delete the file from the publication list to avoid clutter.

In an exemplary embodiment the ASP provides the open platform template provider with the ability to create static and dynamic account groups. Static groups change only when the open platform template provider updates it, while dynamic groups add and drop recipients as the recipients information changes. This means that a open platform template provider may create a report that uses filters to automatically pull out intended recipients based on certain selected criteria. Therefore, if dynamic groups are used the open platform template provider does not need to manually update the list of recipients prior to distribution because it is done automatically

The ASP portal provides an open platform upon which users can upload their templates 393 for generating reports. The template's industry focus, intended use, data fields and other aspects are determined by the open platform template provider that created the template. The open platform template provider that uploads template 393 can populate the template's fields by hand or use ASP's merge feature to merge the data and the fields in the uploaded template 393. During or after the upload, the open platform template provider may chose to keep the uploaded template 393 private so that only the open platform template provider may use template 393, or the open platform template provider may chose to make template 393 public so that anyone with access to the ASP's template section may use template 393 (e.g., the ASP template section may be password protected or may be available to anyone with an internet connection). The open platform template provider may also allow limited access to template 393 in a number of ways including, but not limited to, the following: allowing only identified entities to use template 393; allowing only those within the open platform template provider's agency to use template 393; allowing only those who are members of a particular organization or on-line community to use template 393; allowing only those that complete and submit and on-line survey to use template 393; allowing only those that register an account to use template 393; allowing only those that pay a fee to use template 393; allowing only those that are customers of the open platform template provider to use template 393; allowing only those that have the correct password to use template 393; setting a time limit for using template 393; or setting a number of uses limit for using template 393. The open platform template provider may chose to set up permissions on template 393 so that certain aspects cannot be modified, such as a logo or some form of advertisement displayed on template 393 and/or generated report. The open platform template provider may chose to make template 393 downloadable or accessible exclusively through the ASP.

Once template 393 is uploaded and stored in the template library, the open platform template provider that uploaded template 393 may choose to make template 393 available to others within the open platform template provider's agency so that other employees or agents can use distribute similar items to their clients. One advantage of this arrangement is that an agency will appear more professional by distributing uniform items to all of its clients regardless which agent manages an account. In an exemplary embodiment the open platform template provider may use the uploaded templates 393, and/or templates 393 created using the ASP tools, as part of an express campaign described in detail above.

Client management is facilitated by utilizing template 393 and is supplemental by data management system's client management tracking functionality. According to other various alternative and exemplary embodiments, the data management application may be used by entities other than application service providers. For example, the application may be configured for use by a company for collaborating in real-time with its customers (or suppliers or other parties), such as on the creation of certain documents, presentations, or other files.

Now referring to FIG. 33, FIG. 33 shows data management system's user account screen 240 which displays an Industry Training section 260, Open Proposals section 270, Open RFPs section 280, Client Plans Requiring Attention section 290, Open Activities section 300 and Pending Renewals section 310. User Account screen 240 allows users to quickly gain access to the data needed to perform their work duties.

Industry Training section 260 lists the upcoming industry training sessions. The user simply clicks on session name 262 to register. The user can also see more details regarding the training sessions by clicking on the more link for that specific training session.

Open Proposals section 270 lists the number of proposals that are still active. The user can change which proposals are shown here by personalizing Open Proposals section 270. In an exemplary embodiment, the user can change Open Proposals section 270 to include only clients/prospects assigned to the user, only clients/prospects assigned to any team on which the user is a member or display all clients/prospects for their agency.

Open RFPs section 280 lists the number of RFPs that are still active. The user can change which RFPs are shown here by personalizing Open RFPs section 280. In an exemplary embodiment, the user can change Open RFPs section 280 to include only clients/prospects assigned to the user, only clients/prospects assigned to any team on which the user is a member or display all clients/prospects for their agency.

Client Plans Requiring Attention section 290 lists client plans that have ended, but do not have an ending policy status assigned. The user can choose to show only plans that are currently in the waiting period or plans that are beyond the waiting period. The plans that are in their waiting period are plans that have passed their end date, but have not yet exceeded the waiting period. The plans beyond the waiting period are plans that have exceeded this waiting period. The latter plans cannot be changed and do not require the user to fill in the ending status for the plan. One skilled in the art will recognize that the type of plans will change over time and that numerous plan types could be used in the insurance brokerage industry.

Open Activities section 300 lists open activities that the user has created or activities that have been assigned to the user by others. The user can view this information in any specified timeframe. In an exemplary embodiment, the user has three options. The user can view this information for today, the next seven days or the next thirty days. Any overdue activities are highlighted for the user and a management report is generated. The management report is used to ensure that producers are completing assignments in a timely fashion.

Pending Renewals section 310 displays pending renewals for both clients and prospects. The user can view this information in any specified timeframe. In the exemplary embodiment, the user has four options. The user can view this information for the next thirty days, the next sixty days, the next ninety days or the next one hundred and twenty days. Pending Renewals section 310 allows the producer to proactively ensure policy holders receive the appropriate amount of attention to entice the policy holders to renew their policy.

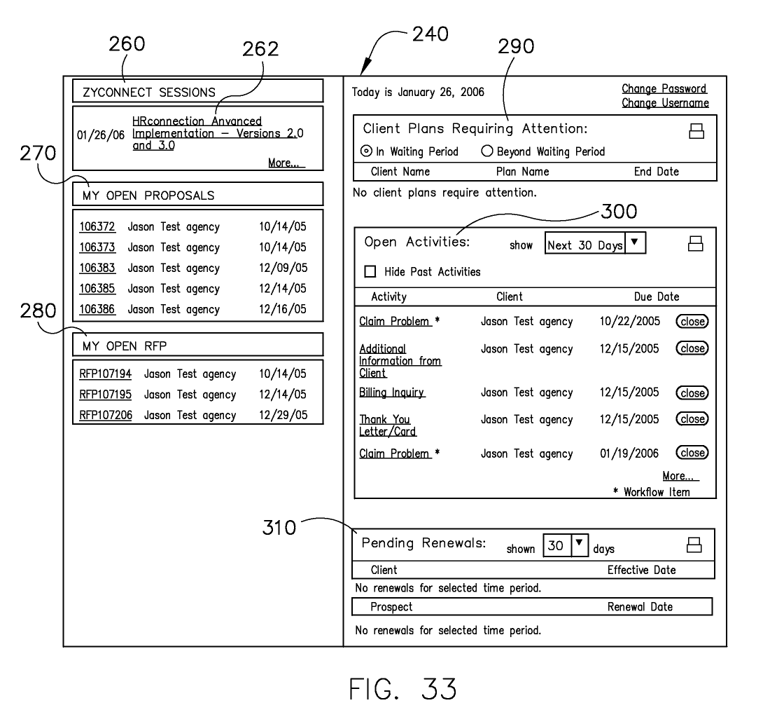

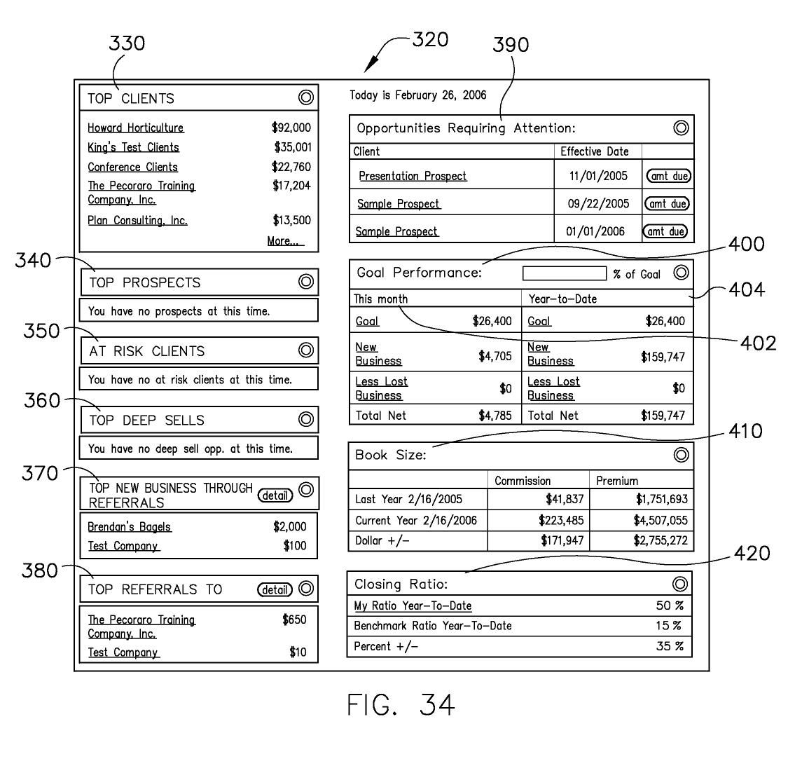

Referring now to FIG. 34, FIG. 34 shows Sales View screen 320 which displays Top Clients section 330, Top Prospects section 340, At Risk Clients section 350, Top Deep Sells section 360, Top New Business Through Referrals section 370, Top Referrals To section 380, Opportunities Requiring Attention section 390, Goal Performance section 400, Book Size section 410 and Closing Ratio section 420.

Top Clients section 330 list any specified number of top clients (e.g. 10, 20, 100) based on a financial matrix (e.g. commissions) which is assigned in the Plan Information section of data management system. In an exemplary embodiment, the top five clients are listed in descending order by expected commission. The user can click on the more link to view a list of all of the clients shown in descending order by expected commission.

The Plan Information section stores the detailed plan information. In an exemplary embodiment, this information comprises: client name; plan type; related opportunity; plan name; plan year; policy first written date; carrier policy number; issuing carrier; billing carrier; beginning policy status; is the plan at risk factor; ending policy status; pay mode; billing mode; commission producer; customer service representative; annual commission; annual premium; current subscribers and release to an internal benefits page. The release to an internal benefits page is the subscriber own personal benefits page, which may list their medical coverage, dental coverage, life insurance coverage or any other benefit.

Top Prospects section 340 list any specified number of top prospects (e.g. 10, 20, 100) based on a producer (e.g. salesperson) and/or financial matrix (e.g. commissions). In an exemplary embodiment, the top five prospects are listed in descending order by expected commission. The user can click on the more link to view a list of all of the prospects shown in descending order by expected commission. Top Prospects section 340 allows the producer and management to focus the company's resources on closing their highest financially beneficial transactions.

At Risk Clients section 350 list any specified number of at risk customers (e.g. 10, 20, 100) based on a producer (e.g. salesperson) and/or financial matrix (e.g. commissions) which is assigned on the Plan Information section of data management system. In an exemplary embodiment, the top five at risk clients are listed in descending order by expected commission. The user can click on the more button to view a list of all of the at risk clients shown in descending order by expected commission. At Risk Clients section 350 allows the producer and management to focus the company's resources on clients that may terminate their relationship with the company.

Top Deep Sells section 360 displays clients that are also prospects to purchase additional plans. Top Deep Sells section 360 list any specified number of deep sells customers (e.g. 10, 20, 100) based on a producer (e.g. salesperson) and/or financial matrix (e.g. commissions) which is assigned on the Plan Information section of data management system. In an exemplary embodiment, the top five deep sells are listed in descending order by expected commission. The user can click on the more link to view a list of all of the deep sells shown in descending order by expected commission. Top Deep Sells section 360 allows the producer and management to focus the company's resources on cross selling other product offerings to existing clients.

Top New Business Through Referrals section 370 display any new business that was referred by another individual within the brokerage. Top New Business Through Referrals section 370 list any specified number of new business referrals (e.g. 10, 20, 100) based on a financial matrix (e.g. commissions) which is assigned on the Plan Information section of data management system. In an exemplary embodiment, the top five new business referrals are listed in descending order by expected commission. The user can click on the more link to view a list of all of the new business referrals shown in descending order by expected commission. Top New Business Through Referrals section 370 allows management to encourage and reward other individuals (e.g. assistances, managers) to participate in sales activities.

Top Referrals To section 380 list the referrals made to producers within the agency. Top Referrals To section 380 list any specified number of top referrals (e.g. 10, 20, 100) based on a financial matrix (e.g. commissions). In an exemplary embodiment, the top five top referrals are listed in descending order by expected commission. The user can click on the more link to view a list of all of the top referrals shown in descending order by expected commission. Top Referrals To section 380 also allows management to encourage and reward other individuals (e.g. assistances, managers) to participate in sales activities.

Opportunities Requiring Attention section 390 displays any unsold opportunities that have an effective date prior to the current date. The user can remove an unsold opportunity from this section in two ways. First, the user can change the effective date of the unsold opportunity to a future date. Second, the user can remove the unsold opportunity from the section by selecting the corresponding remove button. Opportunities Requiring Attention section 390 highlights prospects that were projected to be closed by this date but have not been closed for some reason. Opportunities Requiring Attention section 390 allows the producer and management to reassess the opportunity and develop a plan for its closure or abandonment.

Goal Performance section 400 can display numerous categories. In an exemplary embodiment, Goal Performance section 400 displays two categories. First, This Month category 402, which displays an annual calendar-year goal, new business, lost business and net business for the current month. Second, Year-To-Date category 404, which displays an annual calendar-year goal, new business, lost business and net business for the year. New and lost business is based off the commission producer. The percentage of goal attained is calculated by dividing the year-to-date total net by the annual goal.

Book Size section 410 is the sum of the expected annual commissions on plans for which the producer is the commission producer. In an exemplary embodiment, the plans' beginning policy status is equivalent to the sales tracking status of either “new” or “retain.” However, if the plan is active on the date indicated, but the first written date occurs after the date indicated, that plan will not be included in the calculation for that year.

Closing Ratio section 420 displays the producer's ratio year-to-date, benchmark year-to-date, and the difference between the two. The ratio year-to-date is calculated by dividing the total number of sold opportunities by the total number of opportunities. The benchmark year-to-date is calculated by dividing the total number of sold opportunities by the total number of opportunities for the entire agency.

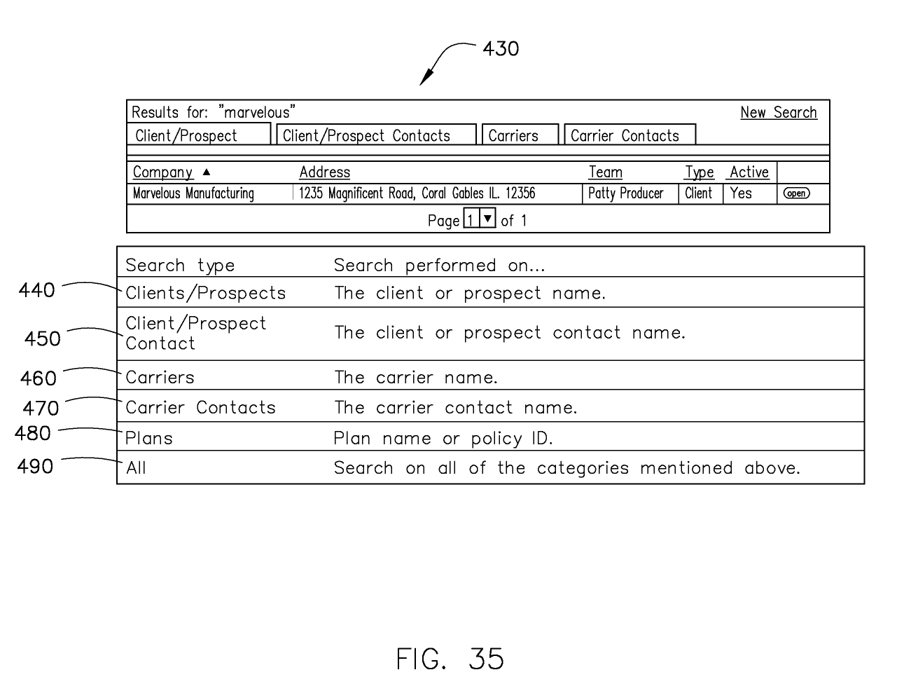

Now referring to FIG. 35, FIG. 35 shows data management system's basic search feature page 430. Basic search feature page 430 is keyed from clients/prospect names 440, client/prospect contact 450, carriers 460, carrier contacts 470, plans 480 or all of these criteria 490. The advanced search feature is keyed from the basic search criteria along with any other criteria in the database. The advanced search is able to locate ranges within a criteria (e.g. clients with <50 employees).

In an exemplary embodiment, data management system is configured with a client/prospect management and communication functionality. The client/prospect management functions include adding contacts, converting a prospect to a client, adding client/prospect notes, adding activities and adding client/prospect attachments.

In an exemplary embodiment, data management system is configured to store the following fields when the users add a client/prospect:

| Field | Description |
|---|---|
| Salutation | Choose the appropriate salutation (e.g. Mr., Mrs., |
| | Ms., or Dr.) |
| First Name | |
| Last Name | |
| Title | |
| Email | |
| Address | |
| Address2 | If necessary, enter an additional line of street |
| | address information for the contact (e.g. suite |
| | number) |
| City | |
| County | |
| State/Province | |
| Zip Code | |
| Phone | |
| Mobile Phone | |
| Fax | |
| Birth Date | |
| Primary Contact | Select this box if this contact should be considered |
| | as a primary contact for this client. There can be |
| | multiple primary contacts. |
| Additional | This is a customized field |
| Information | |
| MyWave Settings | The fields in this section are disabled until the user |
| | specify an email address for this client. |
| Activate MyWave | Select Yes to allow this user to have access to their |
| | company's MyWave site. |
| Administrative | Select Yes to give this user administrative access |
| Rights | to their company's MyWave site. |
| Send Notification | Select Yes to cause Data management system |
| Email | application to automatically send an email to this |
| | user to inform them that their MyWave account |
| | has been activated. |
| Receive MyWave | This field lists whether this user is set up to receive |
| Emails | emails from MyWave. |
| Access To | Choose which specific MyWave applications that |
| | this user should have access to. |

After the client or prospect has been added to data management system, the users can edit this information. In an exemplary embodiment, the user can edit the following data fields:

| Field | Description |
|---|---|
| Salutation | Choose the appropriate salutation (e.g. Mr., Mrs., |
| | Ms., or Dr.) |
| First Name | |
| Last Name | |
| Title | |
| Email | |
| Address | |
| Address2 | If necessary, enter an additional line of street |
| | address information for the contact (e.g. suite |
| | number) |
| City | |
| County | |
| State/Province | |
| Zip Code | |
| Phone | |
| Mobile Phone | |
| Fax | |
| Birth Date | |
| Primary Contact | Select this box if this contact should be considered |
| | as a primary contact for this client. There can be |
| | multiple primary contacts. |
| URL | Enter the web address (URL) for the client. If a |
| | value is entered here, the client's name will act as |
| | a link to that URL from the client home page in the |
| | Data management system application |
| Account Type | Select whether this account is a Group or |
| | Individual account. |
| Number Of | Enter an approximate number of employees at this |
| Employees | client. |
| Number Of Retirees | Enter an approximate number of retirees at this |
| | client. |
| Year Founded | Enter the year that this client company was |
| | founded |
| SIC ID | Select the SIC ID that corresponds to this |
| | client/prospect's business type. |
| Business Line | Enter information to further define the SIC |
| | category for this company. |
| Display This Client | Choose Yes to show this client in the Pending |
| In The Renewal | Renewals section of the Builder Account View |
| Calendar | home page, when the client's plan nears the |
| | renewal timeframe. |
| Additional | This is a customized field |
| Information | |
| MyWave Settings | The fields in this section are disabled until the user |
| | specify an email address for this client. |
| Activate MyWave | Select Yes to allow this user to have access to their |
| | company's MyWave site. |
| Administrative | Select Yes to give this user administrative access |
| Rights | to their company's MyWave site. |
| Send Notification | Select Yes to cause Data management system |
| Email | application to automatically send an email to this |
| | user to inform them that their MyWave account |
| | has been activated. |
| Receive MyWave | This field lists whether this user is set up to receive |
| Emails | emails from MyWave. |
| Access To | Choose which specific MyWave applications that |
| | this user should have access to. |

In an exemplary embodiment, the user converts a prospect to a client in data management system by adding the prospect to the data management system, creating an opportunity plan, recording the quoted plan, associating the quoted plan with the opportunity via the related opportunity plan, creating a RFP, creating a proposal and closing the proposal.

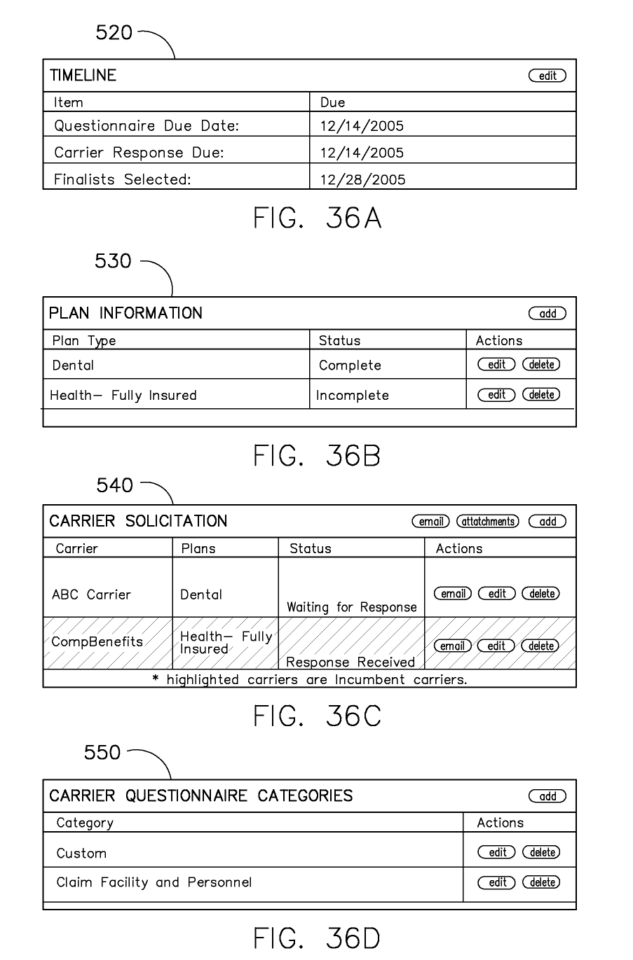

Referring now to FIGS. 36A-36D, a RFP may be created by using Data management system's RFP wizard. The wizard has five steps which include timeline step 520, plan information step 530, carrier solicitation step 540, questionnaire step 550 and a finish step.

In timeline step 520, the system requires a specific number of dates that revolve around the timeline of the RFP. In an exemplary embodiment, timeline step 520 has the following fields which are calendar button enabled:

| Field | Description |
|---|---|
| Carrier Response | Choose the date by which the carrier must respond |
| Due | to the request for information. |
| Reminders Sent | Choose the date on which Data management |
| To Carrier | system should send an automatically-generated |
| | email to the carrier telling them that the request for |
| | information response has not yet been received. |
| | Only carriers with the waiting for response status |
| | will receive reminder emails. This feature can be |
| | reset to send additional reminders. |
| Intent To Bid | Choose a date by which you expect a reply to the |
| Reply Due | intent to bid. |
| Questionnaire Due | Choose a date by which responses to your |
| | questionnaire are due. |
| Finalist Selected | Choose a date by which the user expects to have |
| | selected the finalists for the proposal. |
| Finalist Interviews | Choose a date on which the user plans to interview |
| | the finalists. |
| On-Site Interviews | Choose a date on which the user plans to conduct |
| | on-site interviews with the finalists. |

In Plan Information step 530, the system requires the selection of the plan types (e.g. lines of coverage) that will be included in the RFP. The system may also require the entry of some additional information about each of the plan types. In an exemplary embodiment, the system requires the following information:

| Field | Description |
|---|---|
| Plan Year To Quote | Enter the start and end dates of the plan year that |
| | the carrier should quote. |
| Plans To Include | Select any current plans to include in the RFP. |
| Is This A Renewal | Choose Yes if the carrier is quoting a renewal of a |
| Of A Current Plan | current plan. Choose No if the carrier is quoting a |
| In Data management | new plan. |
| system | |
| Should The Carrier | If the client currently has a plan, choose whether |
| Duplicate Benefits | the carrier should quote the same benefit items as |
| | in the prior plan. Choose No if the carrier is |
| | quoting a totally new plan type. |
| Additional | Add any additional information to help instruct the |
| Information | carriers about the plans they should be quoting. |

In Carrier Solicitation step 540, the system is configured to require the selection of which carriers to include in the bidding process. The user selects the appropriate carriers, attaches the relevant proposal information and primary contact information.

In Questionnaire step 550, the system is configured to require the selection of whether to send a questionnaire with the RFP. If the user includes this information, the carriers are required to answer the questionnaire as part of the RFP process.

In the Finish step, the system is configured to require the user to select a complete or edit the RFP button. The user verifies that an RFP number has been created. This RFP number uniquely identifies each RFP and is used in the RFP tracking process. After creating an RFP, the user can still change the details of the RFP via the RFP's home page.

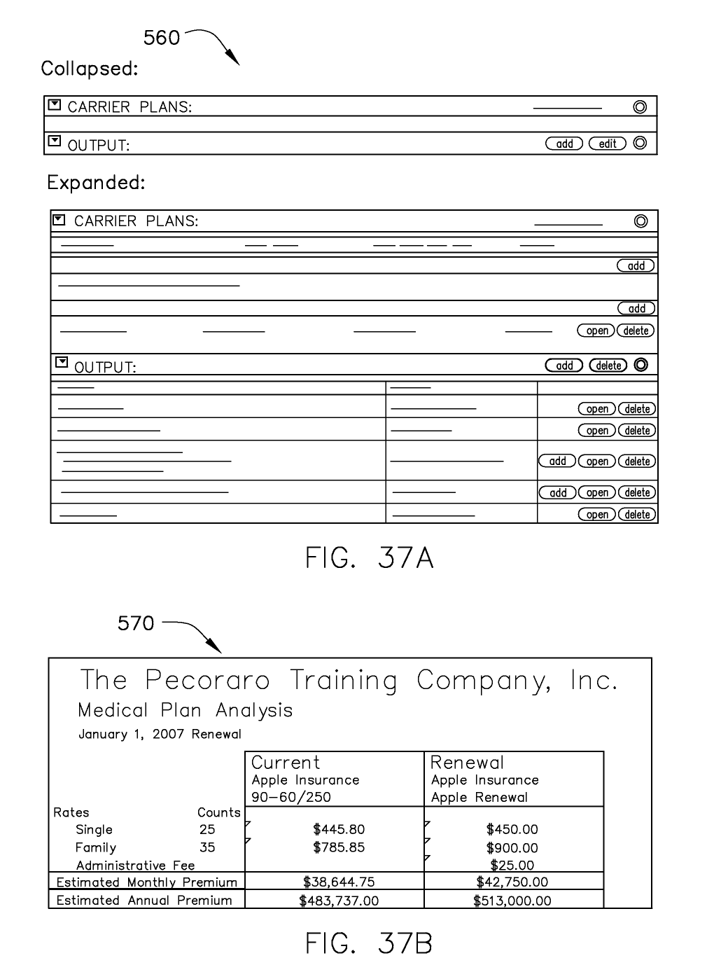

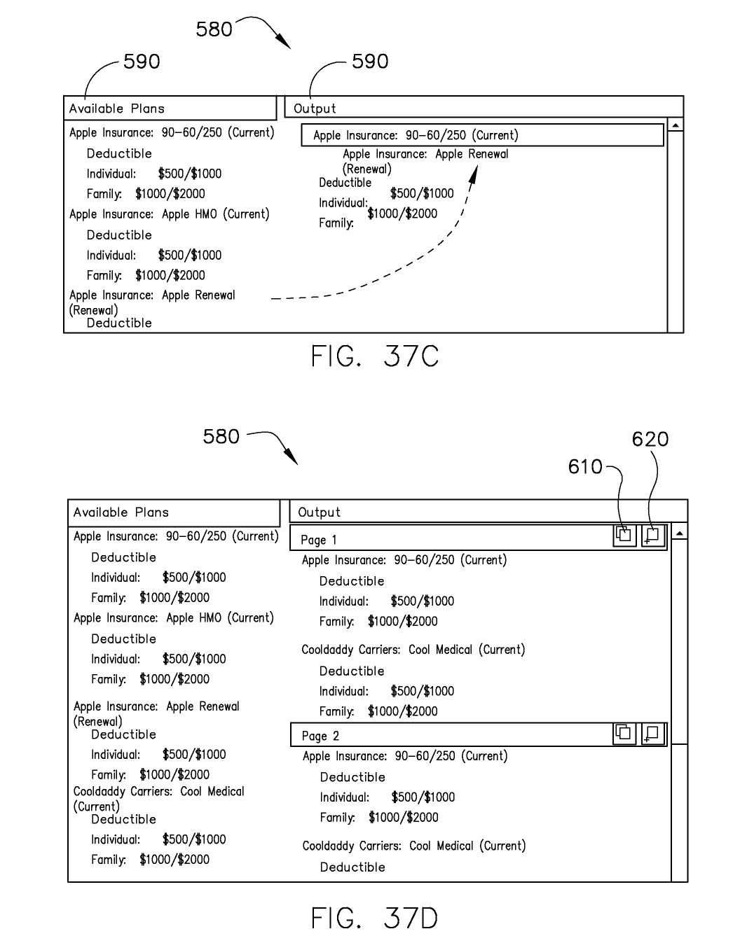

Referring now to FIGS. 37A-37D, the system is configured to create a proposal in Proposal homepage 560. After at least one carrier has the status of quote received, and all plan types have a status of completed, the system can generate a new proposal. In an exemplary embodiment, the user may select the appropriate client and RFP, and modifies the plan rate structures, market studies, carrier plans and proposal output pages.

In an exemplary embodiment, the user can modify the RFP which automatically updates the proposal with the new modifications. The user can add, subtract, or modify the plan rate structures. The plan rate structures are used to make sure that plan rates are displayed in a uniform fashion in data management system's cost analysis. The plan rate structures can be tiered, complex, fixed, volume or self funded.

Market Study pages are generated by data management system from the information entered into Proposal homepage 560. The Market Study can be viewed by plan type or carrier. As data is updated in Proposal homepage 560, these updates will automatically be incorporated into the Market Study. The carriers that are selected to participate in the RFP will be incorporated into the Market Study depending on their status. In an exemplary embodiment, the status available for the carriers requested to participate in the RFP are:

| Status | Description |
|---|---|
| Declined | Select this status when a carrier declines the RFP |
| | instead of sending a quote, but your agency would |
| | like to include record of submitting a RFP to that |
| | carrier in the market study. |
| No Response | Select this status when a carrier has not responded |
| | to the RFP by the time of the presentation, but |
| | your agency wants the status to display as |
| | Complete. |
| Non-Competitive | Select this status when a carrier quote was |
| | received, but your agency decided not to illustrate |
| | any plans because they were non-competitive. |
| Response Received | Select this general status to record that a response |
| | was received, but delay a decision on a more |
| | specific market study status. |
| Refer To Analysis | Select this status if your agency wants to illustrate |
| | plans in the proposal for this carrier. This status |
| | must be selected to display any plans in the cost |
| | analysis. |
| Waiting For | Select this general status if your agency hasn't |
| Response | received a quote from this carrier, and you don't |
| | want the status of this item to appear as Complete. |

The system may be edited, viewed, printed or attached to a proposal. The data management system's proposal output sections include:

| Type of Output | Description |
|---|---|
| Agency Template | Agency templates are documents loaded on the |
| | administrative side of Data management system |
| | for frequent or consistent usage in proposal |
| | outputs. Examples include: cover page, |
| | disclaimer page, table of contents, account team |
| | bios, company information, and value added |
| | services documents. |
| Output Attachment | Output attachments include non-template |
| | documents that need to be included to represent the |
| | full contents of the actual presentation proposal. |
| | Examples include: carrier quotes and |
| | client/prospect-specific risk questionnaires. |
| Market Study | The Market Study is a Data management system |
| | generated document. The Market Study is updated |
| | from the Proposal home page and is created per |
| | plan type. |
| Cost Analysis | The Cost Analysis is a Data management system |
| | generated document. The Cost Analysis is |
| | updated from the Proposal home page and is |
| | created per plan type. |
| Uploaded Cost | An Uploaded Cost Analysis is generated from the |
| Analysis | Data management system Cost Analysis page. |
| | The Uploaded Cost Analysis is a Data |
| | management system upload macro saved in |
| | Excel ® format and recorded in the presentation |
| | versions of the proposal. |

In an exemplary embodiment, the data management system can be used to generate cost analysis pages from the information entered in the Proposal homepage 560. As data is updated in Proposal homepage 560, these cost analysis pages are dynamically updated. Before the system can create a cost analysis, the system must have a designated rate structure for the plan type. The cost analysis displays all plans added to the carrier plans section, plus carriers in the Market Study section associated with the selected plan type. The system may be edited and the cost analysis output may be sent directly to spreadsheet report 570 (e.g., using Excel®). The cost analysis may be saved to the data management system (See FIG. 17B).

To create a cost analysis the system must be formatted in the manner in which the plans will be displayed as the output. This includes the display order on each page, as well as the number of output pages. In Cost Analysis homepage 580 the user can click and drag plans in Available Plan section 590 to Output section 600 (See FIG. 37C). The user repeats this process to add more plans to Output section 600 and can reorder the plans in the Output section 600 by clicking on the plans to be moved and dragging the plan to its new location. If necessary, the user can create multiple option plans by clicking on Add Group to Page icon 610 in Cost Analysis homepage 580 (See FIG. 37D). The user may also add an additional page to spreadsheet report 570 by clicking on Add Page Below icon 620.

In an exemplary embodiment, data management system is configured to track commission. The Commission section can be searched, edited and reports can be generated from this commission information.

In an exemplary embodiment, data management system can be used in tandem with Microsoft Outlook to synchronize carrier, prospect, or client contacts in data management system to their local address book in Outlook. When the synchronizing function is running, the user can seamlessly save inbound and outbound emails with attachments as data management system activities.

In an exemplary embodiment, data management system can be used in tandem with an application program and a data management application to allow companies in the insurance brokerage industry to manage and distribute software-based services and solutions to customers across a wide area network (e.g., the Internet) from a central data center (e.g., ASPs).

According to various alternative and exemplary embodiments, the data management application may be configured to enable real-time file collaboration without a cumbersome upload/download process; to enable the “pushing” of content and/or messages directly to the desktop of users, which can supplement an application service provider's use of e-mail messages to launch new products, deliver content, or deliver key messages; to enable a single sign-on launching pad to any of an application service provider's products that could also be used to sign-on to other 3rd party products if they are using the data management application; and to enable real-time instant messaging and/or support tickets.

According to other various alternative and exemplary embodiments, the data management application is configured to perform or enable the performance of the following functions: 1) the sharing of files on Internet sites as if they existed on your desktop or network; 2) the near real-time collaboration of files; 3) the treatment of Internet files as though they have taken on the same properties as local files; 4) the use of a Windows service that controls updates to the programs of an application service provider, for example; and 5) the implementation of a real-time messaging system and report delivery application.

According to other various alternative and exemplary embodiments, the data management application may be used by entities other than application service providers. For example, the application may be configured for use by a company for collaborating in real-time with its customers (or suppliers or other parties), such as on the creation of certain documents, presentations, or other files.

It is important to note that data management system 60 and content generation engine 61 are illustrated as an integrated system. However, data management system 60 and content generation engine 61 may also be separate system with minimal, limited or no communication with each other.

It is important to note that the term “data management system” is intended to be a broad term and not a term of limitation. According to various alternative and exemplary embodiments, the data management system may be used with any of a variety of different hardware, software, programs, applications, etc. and is not intended to be limited to use by application service providers, but may be used by one or more of a variety of different entities in any arrangement where the functionality of the data management application (e.g., the addition of out of network files to a user's Windows Explorer interface, the ability to manipulate remote files in the same way local files are manipulated, etc.) is desirable.

The disclosure is described above with reference to drawings. These drawings illustrate certain details of specific embodiments that implement the systems and methods and programs of the present disclosure. However, describing the disclosure with drawings should not be construed as imposing on the disclosure any limitations that may be present in the drawings. The present disclosure contemplates methods, systems and program products on any machine-readable media for accomplishing its operations. The embodiments of the present disclosure may be implemented using an existing computer processor, or by a special purpose computer processor incorporated for this or another purpose or by a hardwired system.

As noted above, embodiments within the scope of the present disclosure include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the disclosure are described in the general context of method steps which may be implemented in one embodiment by a program product including machine-executable instructions, such as program code, for example, in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present disclosure may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, servers, minicomputers, mainframe computers, and the like. Embodiments of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the disclosure might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules, and other data for the computer.

It should be noted that although the flowcharts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the disclosure have been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated.

What is claimed is:

1. A computer-implemented data processing system comprising:
a database, the database being configured to store information regarding a plurality of insurance brokerage industry projects;
a file server coupled to the database;
a broker user interface logic coupled to the file server, the broker user interface logic being configured to provide a broker user interface accessible to brokers from a client device, the broker user interface logic being configured to receive commands via a communications network from the client device to access a data file in the database and to permit the data file to be displayed as a local file in a file directory on the client device and to permit the brokers to add information in the database concerning the plurality of insurance brokerage industry projects; and
an application service provider user interface logic coupled to the file server, the application service provider user interface logic being configured to provide an application service provider user interface accessible to a service provider, the service provider having relationships with the brokers in which the service provider provides data management applications for the plurality of insurance brokerage industry projects.

2. The computer-implemented data processing system of claim 1, wherein one of the data management applications is configured to be a request for proposal application, the request for proposal application comprising at least one of a timeline module, a plan information module, a carrier solicitation module, a questionnaire module, and a finish module.

3. The computer-implemented data processing system of claim 2, wherein a proposal is automatically generated based on data received from at least one of the timeline module, the plan information module, the carrier solicitation module, the questionnaire module and the finish module.

4. The computer-implemented data processing system of claim 3, wherein the proposal further comprises a market study and a cost analysis.

5. The computer-implemented data processing system of claim 2, wherein a proposal comprising a market study is generated.

6. The computer-implemented data processing system of claim 2, wherein a proposal comprising a cost analysis is generated.

7. The computer-implemented data processing system of claim 1, further comprising a template engine coupled to the file server, the template engine being configured to create a plurality of industry specific templates.

8. The computer-implemented data processing system of claim 1, wherein the broker user interface is configured to access the database via the internet.

9. The computer-implemented data processing system of claim 8 wherein the application service provider user interface logic and the broker user interface logic each include logic which respectively permits service providers and brokers to generate reports based on the information in the database concerning the plurality of insurance brokerage industry projects.

10. The computer-implemented data processing system of claim 8 wherein the database implements a shared architecture, the shared architecture being shared by multiple brokers with the service provider having the ability to add to and edit a content in the shared architecture.

11. The computer-implemented data processing system of claim 8 wherein the broker user interface is configured to operate on the client device and wherein the file server synchronizes a data file modification between the client device and the database.

12. The computer-implemented data processing system of claim 1, wherein the database implements a shared architecture, the shared architecture being shared by multiple brokers with the service provider having the ability to add to and edit a content in the shared architecture.

13. The computer-implemented data processing system of claim 1, wherein the broker user interface logic is configured to permit the brokers to perform quality control of the information added by the brokers into the database.

14. The computer-implemented data processing system of claim 1, further comprising prioritization logic, the prioritization logic being configured to prioritize the plurality of insurance brokerage industry projects.

15. The computer-implemented data processing system of claim 1, wherein the application service provider user interface logic and the broker user interface logic each include logic which respectively permits service providers and brokers to generate reports based on the information in the database concerning the plurality of insurance brokerage industry projects.

16. The computer-implemented data processing system of claim 15 wherein the file server is configured to include a web based distributed authoring and versioning logic.

17. The computer-implemented data processing system of claim 15 wherein the client device is configured to include a web based distributed authoring and versioning logic.

18. A computer-implemented data processing system, comprising:
a database, the database being configured to store information regarding a plurality of insurance brokerage industry projects;
a file server coupled to the database;
a content template logic;
a broker user interface logic coupled to the file server, the broker user interface logic being configured to provide a broker user interface accessible to brokers from a client device, the broker user interface logic being configured to receive commands via a communications network from the client device to access a data file in the database and to permit the data file to be displayed as a local file in a file directory on the client device and to permit the brokers to add information in the database concerning the plurality of insurance brokerage industry projects;
an application service provider user interface logic coupled to the file server, the application service provider user interface logic being configured to provide an application service provider user interface accessible to a service provider, the service provider having relationships with the brokers in which the service provider provides data management applications for the plurality of insurance brokerage industry projects;
wherein the file server cooperates with the client device to display a portion of a data file on the client device as a local system file;
wherein the portion of a data file is configured to be modified by a client device; and
wherein the file server synchronizes a data file modification between the client device and the database;
wherein the application service provider interface logic receives at least a file command from a plurality of client devices and cooperates with the plurality of client devices to transmit a data file based on a control signal sent by a data access layer logic.

19. The computer-implemented data processing system of claim 18 wherein the file server is configured to include a web based distributed authoring and versioning logic.

20. The computer-implemented data processing system of claim 19 wherein the file server is further configured to include a data access layer and wherein the client device is further configured to include a service manager.

21. A computer-implemented method for database management, comprising:
storing at least a data file in an application service provider database, the application service provider database being configured to store information regarding a plurality of insurance brokerage industry projects;
receiving at least a file command from a plurality of client devices to an application service provider server;
communicating the data file to one of the plurality of client devices;
displaying the data file as a local system file in a file directory on the client device;
wherein the application service provider database further includes an application service provider user interface logic coupled to the application service provider server, the application service provider user interface logic being configured to provide an application service provider user interface accessible to a service provider, the service provider having relationships with the brokers in which the service provider provides data management applications for the plurality of insurance brokerage industry projects; and
wherein the client device is configured to include a broker user interface logic coupled to the application service provider server, the broker user interface logic being configured to provide a broker user interface accessible to brokers from the client device, the broker user interface logic being configured to receive commands via a communications network from the client device to access a data file in the application service provider database and to permit the data file to be displayed as a local file in a file directory on the client device and to permit the brokers to add information in the database concerning the plurality of insurance brokerage industry projects.

22. The computer-implemented method of claim 21, further comprising a template engine coupled to the application service provider server, the template engine being configured to create a plurality of industry specific templates.

23. The computer-implemented method of claim 21, further comprising modifying the data file;
storing a modified data file in the application service provider database; and
synchronizing the modified data file between the client device and the application service provider database.

24. The computer-implemented method of claim 23, wherein the data file is modified in the application service provider database.

25. The computer-implemented method of claim 23, wherein the data file is modified in the client device.
